(19) United States
(12) Patent Application Publication
(10) Pub. No.: US 2026/0161939 A1
(43) Pub. Date: Jun. 11, 2026

(54) LEARNING DEVICE OF NEURON MODULE AND METHOD OF OPERATING THE SAME

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Yoonmyung LEE, Suwon-si (KR); Donghyun PARK, Suwon-si (KR); Hajung MUN, Suwon-si (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 19/180,760

(22) Filed: Apr. 16, 2025

(30) Foreign Application Priority Data
Jun. 12, 2024 (KR) 10-2024-0076459

(51) Int. Cl. G06N 3/08; G06N 3/049

(52) U.S. Cl. CPC G06N 3/08; G06N 3/049

(57) ABSTRACT

A learning device of a neuron module includes one or more processors configured to execute instructions to determine, based on predetermined hyperparameters and a weight of a synapse of a plurality of synapses coupled with the neuron module in a spiking neural network, a maximum value of a graph and a reference decrease of the graph with respect to a reference time interval from among a plurality of time intervals of the graph, determine, based on the maximum value and the reference decrease, a weight variance of the synapse corresponding to a time difference between a post-spike occurring in the neuron module and a pre-spike occurring in the synapse by determining a target decrease of the graph with respect to a target time interval including the time difference from among the plurality of time intervals, and update the weight of the synapse based on the weight variance.

### CROSS-REFERENCE TO RELATED APPLICATIONS

This application claims benefit of priority under 35 USC § 119 to Korean Patent Application No. 10-2024-0076459, filed on Jun. 12, 2024, in the Korean Intellectual Property Office, the disclosure of which is incorporated by reference herein in its entirety.

### BACKGROUND

### 1. Field

The present disclosure relates generally to machine learning, and more particularly, to a learning device of a neuron module and a method of operating the same.

### 2. Description of Related Art

Neuromorphic hardware may memorize and/or compute numerous data in parallel by mimicking operating principles of a human brain in which numerous neurons may transmit electrical and/or chemical signals in parallel to process and/or store information and to perform cognitive activities, recognition activities, conscious activities, or the like. For example, a von Neumann-type hardware, which may sequentially process input data, may exhibit satisfactory performance when performing simple numerical calculations and/or execution of precisely written programs. However, due to structural constraints (e.g., processing bandwidth or the like), the von Neumann-type hardware may only achieve a relatively low efficiency in processing and/or understanding images and/or sounds for pattern recognition, real-time recognition, and/or speech recognition, in particular, when compared to a manner in which a human may analyze and/r understand the images and/or sounds. That is, the ability of the related devices to perform these human-like tasks may be constrained by structural limitations that may include, but not be limited to, processing bandwidth and the like.

### SUMMARY

One or more example embodiments may address at least some of the problems and/or disadvantages described above and/or other disadvantages not described above. In addition, the example embodiments may not be required to overcome the disadvantages described above, and an example embodiment may not overcome any of the problems described above.

According to an aspect of the present disclosure, a learning device of a neuron module includes a memory storing instructions, and one or more processors communicatively coupled to the memory. The one or more processors are configured to execute the instructions to determine, based on predetermined hyperparameters and a weight of a synapse of a plurality of synapses coupled with the neuron module in a spiking neural network, a maximum value of a graph and a reference decrease of the graph with respect to a reference time interval from among a plurality of time intervals of the graph. The one or more processors are further configured to execute the instructions to determine, based on the maximum value and the reference decrease, a weight variance of the synapse corresponding to a time difference between a post-spike occurring in the neuron module and a pre-spike occurring in the synapse by determining a target decrease of the graph with respect to a target time interval including the time difference from among the plurality of time intervals. The one or more processors are further configured to execute the instructions to update the weight of the synapse based on the weight variance. The graph includes linear graphs respectively included in the plurality of time intervals.

In some embodiments, the one or more processors of the learning device may be further configured to execute the instructions to sequentially search for a first value from a most significant bit (MSB) among bits representing the time difference, and determine the target time interval from the plurality of time intervals using a first index in which the first value is initially found.

In some embodiments, the one or more processors of the learning device may be further configured to execute the instructions to determine a maximum value of the target time interval by shifting bits representing the maximum value of the graph based on the first index, and determine the weight variance of the synapse based on the maximum value of the target time interval and the target decrease.

In some embodiments, the one or more processors of the learning device may be further configured to execute the instructions to determine the target decrease by shifting bits representing the reference decrease based on the first index.

In some embodiments, the one or more processors of the learning device may be further configured to execute the instructions to determine the weight variance of the synapse using the target decrease and indices in which the first value is found after the first index from among the bits representing the time difference.

In some embodiments, the one or more processors of the learning device may be further configured to execute the instructions to determine a decrease in each index by shifting bits representing the target decrease by each index for the indices in which the first value is found, and determine the weight variance of the synapse by subtracting the decrease in each index from the maximum value of the target time interval.

In some embodiments, the one or more processors of the learning device may be further configured to execute the instructions to determine a number of the plurality of time intervals based on a parameter related to the reference time interval among the hyperparameters and a number of bits of the time difference.

In some embodiments, the one or more processors of the learning device may be further configured to execute the instructions to determine a sign of the weight variance based on a sign of the time difference based on a parameter related to a shape of the graph among the hyperparameters.

In some embodiments, the one or more processors of the learning device may be further configured to execute the instructions to adjust the weight variance by an offset based on a parameter related to an offset applied to the graph among the hyperparameters.

In some embodiments, the one or more processors of the learning device may be further configured to execute the instructions to add noise to the weight variance by applying a random number to the weight variance.

In some embodiments, the one or more processors of the learning device may be further configured to execute the instructions to determine the hyperparameters based on a learning rule of the plurality of synapses.

According to an aspect of the present disclosure, a method of operating a learning device of a neuron module includes determining, based on predetermined hyperparameters and a weight of a synapse of a plurality of synapses coupled with the neuron module in a spiking neural network, a maximum value of a graph and a reference decrease of the graph with respect to a reference time interval from among a plurality of time intervals of the graph. The method further includes determining, based on the maximum value and the reference decrease, a weight variance of the synapse corresponding to a time difference between a post-spike occurring in the neuron module and a pre-spike occurring in the synapse by determining a target decrease of the graph with respect to a target time interval including the time difference from among the plurality of time intervals. The method further includes updating the weight of the synapse based on the weight variance. The graph includes linear graphs respectively included in the plurality of time intervals.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a diagram illustrating an operation of a neuron module of a spiking neural network, according to an embodiment;

FIGS. 2 and 3 are diagrams illustrating a spike-timing dependent plasticity (STDP) learning process, according to an embodiment;

FIG. 4 is a diagram illustrating a learning device of a neuron module, according to an embodiment;

FIG. 5 is a diagram illustrating an STDP curve and a hyperparameter, according to an embodiment;

FIG. 6 is a diagram illustrating an operation of applying different STDP curves depending on a weight of a synapse, according to an embodiment;

FIG. 7 is a diagram illustrating hyperparameters, according to an embodiment;

FIGS. 8 and 9 are diagrams illustrating a first hyperparameter, according to an embodiment;

FIGS. 10 and 11 are diagrams illustrating a second hyperparameter, according to an embodiment;

FIG. 12 is a diagram illustrating a third hyperparameter, according to an embodiment;

FIG. 13 is a diagram illustrating a fourth hyperparameter, according to an embodiment;

FIG. 14 is a diagram illustrating a graph, according to an embodiment;

FIG. 15 is a diagram illustrating a time interval of a graph, according to an embodiment;

FIG. 16 is a diagram illustrating a decrease in each time interval, according to an embodiment;

FIG. 17 is a diagram illustrating a maximum value and a reference decrease of a graph, according to an embodiment;

FIGS. 18 and 19 are diagrams illustrating an operation of determining a target time interval, according to an embodiment;

FIG. 20 is a diagram illustrating an operation of determining a target decrease for a target time interval, according to an embodiment;

FIG. 21 is a diagram illustrating a maximum value of each time interval and a decrease in each time interval, according to an embodiment;

FIG. 22 is a diagram illustrating an operation of finding a first value, according to an embodiment;

FIGS. 23 to 25 are diagrams illustrating an operation of determining a weight variance using indices with found first values, according to an embodiment;

FIG. 26 is a diagram illustrating a decrease in a graph according to a second hyperparameter, according to an embodiment;

FIG. 27 is a diagram illustrating an offset applied to a graph, according to an embodiment;

FIG. 28 is a diagram illustrating a mode of a graph, according to an embodiment;

FIG. 29 is a diagram illustrating noise, according to an embodiment;

FIG. 30 is a diagram illustrating an example of a graph to which an offset, a mode, and noise are applied, according to an embodiment;

FIG. 31 is a diagram illustrating an operation of updating a weight based on a weight variance, according to an embodiment;

FIGS. 32 and 33 are flowcharts illustrating an operation of a learning device of a neuron module to determine a weight variance, according to an embodiment;

FIGS. 34 and 35 are block diagrams illustrating an operation of a learning device of a neuron module to determine a weight variance, according to an embodiment;

FIG. 36 is a diagram illustrating an operation of determining a graph by fixing the number of time intervals, according to an embodiment;

FIGS. 37 and 38 are diagrams illustrating an operation of determining a graph using a subtractor, according to an embodiment;

FIG. 39 is a flowchart illustrating an operation method of a learning device of a neuron module, according to an embodiment; and

FIG. 40 is a block diagram illustrating a learning device of a neuron module, according to an embodiment.

### DETAILED DESCRIPTION

The following structural and/or functional descriptions are provided as an example only and various alterations and modifications may be made to the embodiments. That is, the embodiments are not to be construed as limited to the disclosure and should be understood to include all changes, equivalents, and replacements within the spirit and the technical scope of the disclosure.

As used herein, “A or B”, “at least one of A and B”, “at least one of A or B”, “A, B or C”, “at least one of A, B and C”, “at least one of A, B, or C”, and “one or a combination of at least two of A, B, and C,” each of which may include any one of the items listed together in the corresponding one of the phrases, or all possible combinations thereof. Terms, such as first, second, and the like, may be used herein to describe components. Each of these terminologies is not used to define an essence, order, or sequence of a corresponding component but used merely to distinguish the corresponding component from other components. For example, a first component may be referred to as a second component, and similarly the second component may also be referred to as the first component.

It is to be understood that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. It is to be understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It is to be understood that terms, such as those defined in commonly-used dictionaries, should be interpreted as having a meaning that is consistent with their meaning in the context of the relevant art and may not be interpreted in an idealized or overly formal sense unless expressly so defined herein.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings. When describing the embodiments with reference to the accompanying drawings, like reference numerals may refer to like elements and a repeated description related thereto may be omitted for the sake of brevity.

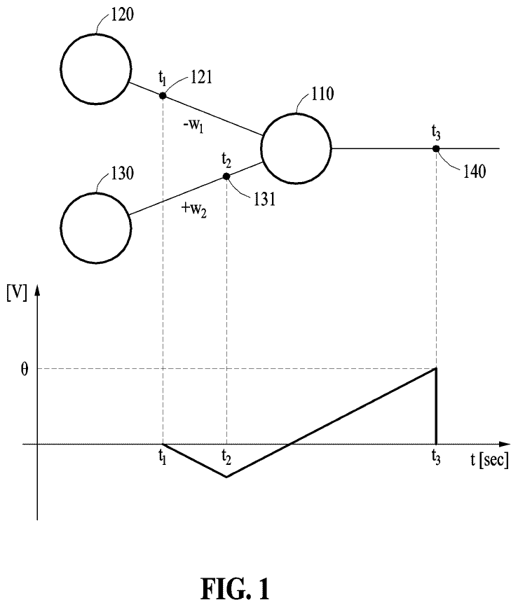

FIG. 1 is a diagram illustrating an operation of a neuron module of a spiking neural network, according to an embodiment. The neuron module may include one or more neurons.

The spiking neural network may be and/or may include a model (e.g., a machine learning model) that may imitate (mimic) a natural (biological) neural network. For example, a realistic neuron model may be used to imitate the mechanism of an actual neuron. The spiking neural network may configure an artificial neural network (ANN) by transmitting and/or receiving a signal in the form of spikes (e.g., 1-bit data). In a similar manner to an operating principle of an actual natural neural network, the impact of a spike may vary depending on a weight set for each synapse. In an embodiment, the weight of a synapse may be updated based on a time between spikes. That is, the weight of the synapse may be updated using one or more of various methods, which may include, but not be limited to, spike-timing dependent plasticity (STDP) which may include, long-term potentiation (LTP) and/or long-term depression (LTD), from among other representative examples of synaptic weight learning rules.

As used herein, STDP may refer to a learning method of adjusting the strength of synaptic connections between neurons. The connection strengths may be adjusted based on a relative timing (e.g., action potential) of output and received input spikes of a specific neuron. Under the STDP process, LTP may occur when an input spike for a predetermined neuron may typically occur immediately before an output spike of the neuron. Thereafter, the specific input may become quite stronger. Alternatively or additionally, when an input spike may typically occur immediately after an output spike on average, LTD may occur. Thereafter, the specific input may become quite weaker. For at least these reasons, the learning method may be referred to as spike-timing dependent plasticity or STDP. As a result, inputs that may cause excitation of a neuron receiving an input spike may be more likely to contribute in the future, whereas inputs that do not cause an output spike may be less likely to contribute in the future. In such a case, since the input spike may be transmitted to a following neuron, a neuron that may cause an input spike may be referred to as a presynaptic neuron, and a neuron that may receive the input spike may be referred to as a postsynaptic neuron.

The STDP learning rule may be and/or may include a time-differential function (e.g., t=t_{POST}−t_{PRE}) between a spike time (t_{PRE} or tin) of a presynaptic neuron and a spike time (t_{POST} or t_{OUT}) of a postsynaptic neuron. In such a manner, the time-differential function may adapt to a synaptic weight of a synapse that may connect the presynaptic neuron to the postsynaptic neuron. In a typical STDP curve graph, when a time difference is positive (e.g., when the presynaptic neuron fires before the postsynaptic neuron), a synaptic weight may increase (e.g., strengthening a synapse), and conversely, when the time difference is negative (e.g., when the postsynaptic neuron fires before the presynaptic neuron), the synaptic weight may decrease (e.g., suppressing the synapse).

In an embodiment of the STDP process, a change in the synaptic weight over time may be performed based on exponential decay.

Referring to FIG. 1, a spiking neural network may include neurons (e.g., a first neuron 110, a second neuron 120, and a third neuron 130) connected by synapses. FIG. 1 illustrates that the first neuron 110 is included in a current layer, that the second neuron 120 and the third neuron 130 are included in a previous layer. However, the present disclosure is not limited in this regard. For example, the spiking neural network may be configured to include more neurons that may be included in various layers and that may be connected by other synapses. In addition, some of the neurons may be connected to other neurons on the same layer through lateral connection, and some other neurons may be connected to a neuron of a previous layer through feedback connection. That is, as used herein, a lateral connection may refer to a synapse connecting two or more neurons of a same layer, and a feedback connection may refer to a synapse connecting one or more neurons of a layer to one or more neurons of a preceding layer.

As shown in the graph at the bottom of FIG. 1, a membrane potential V of the first neuron 110 may change according to a spike of the second neuron 120 fired at a first time point t₁ 121 and a spike of the third neuron 130 fired at a second time point t₂ 131.

Referring to the graph, the membrane potential of the first neuron 110 may decrease based on the spike of the second neuron 120 fired at the first time point t₁ 121 and a weight −w₁ of a connection synapse between the first neuron 110 and the second neuron 120.

The membrane potential V of the first neuron 110 may increase based on the spike of the third neuron 130 fired at the time point t₂ 131 and a weight +w₂ of a connection synapse between the first neuron 110 and the third neuron 130. The first neuron 110 may fire and may generate a spike at a time point t₃ 140 when the membrane potential V of the first neuron 110 reaches a membrane potential threshold θ, and, subsequent to the spike, the membrane potential V of the first neuron 110 may become zero (0). That is, the first neuron 110 may accumulate one or more spikes received from the second neuron 120 and/or the third neuron 130, and when the accumulated membrane potential of the first neuron 110 reaches the membrane potential threshold θ, the first neuron 110 may output a spike. Accordingly, the first neuron 110 may fire up to one spike at a maximum membrane potential θ during an inference process with respect to one input.

In the present disclosure, for ease of description, based on the first neuron 110, a spike input to the first neuron 110 through a synapse may be referred to as a pre-spike, and a spike fired and output from the first neuron 110 may be referred to as a post-spike. In addition, the first neuron 110 may be also referred to as a neuron module. A device for performing the learning technique provided by the present disclosure may be referred to as a learning device of a neuron module.

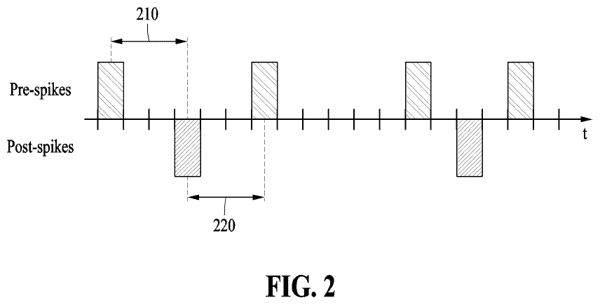

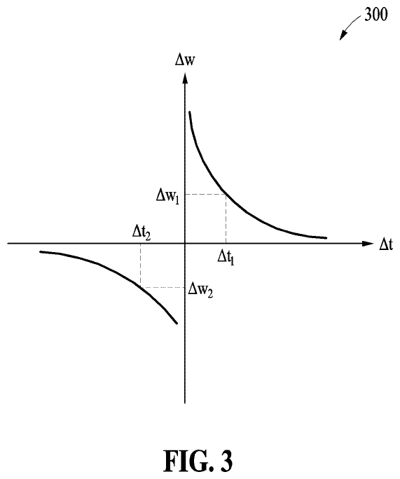

FIGS. 2 and 3 are diagrams illustrating a spike-timing dependent plasticity (STDP) learning process, according to an embodiment.

The STDP learning process provided by the present disclosure may be implemented as unsupervised on-chip learning and may be applied to a neuromorphic processor including a spiking neural network as an ANN learning method. Furthermore, in a system that may reproduce a natural neural network operation by imitating a natural neural network, an STDP function that may be similar to a learning principle of the actual natural neural network may be provided.

Referring to FIG. 2, an example is illustrated to describe a pre-then-post time 210 and a post-then-pre time 220 used for the STDP learning process. In FIG. 2, an upper bar represents a pre-spike and a lower bar represents a post-spike. The pre-then-post time 210 may be a time difference obtained by subtracting a time point of receiving a pre-spike from a time point of occurrence of a post-spike when the post-spike occurs in a neuron module after the neuron module receives the pre-spike. In an embodiment, the pre-then-post time 210 may have a positive value. The pre-then-post time 220 may be a time difference obtained by subtracting a time point of receiving a pre-spike from a time point of occurrence of a post-spike when a neuron module receives the pre-spike after the post-spike occurs in the neuron module. In an embodiment, the pre-then-post time 220 may have a negative value.

Referring to FIG. 3, an example of an STDP curve 300 used for determining a weight variance based on the calculated time difference is illustrated. An x-axis of the STDP curve 300 may represent a time difference (e.g., a time variance At), and a y-axis may represent a weight difference (e.g., a weight variance Aw).

According to the STDP curve 300, since a time variance Δt₁ having a positive value like the pre-then-post time 210 corresponds to a weight variance Δw₁ having a positive value, the positive weight variance Δw₁ may be determined based on the pre-then-post time 210. The weight variance Δw₁ may be added to a current weight of a synapse that receives the pre-spike, and thereby, a weight of the synapse may increase. The weight increase may be referred to as an LTP of a synapse. According to the STDP curve 300, as the pre-then-post time 210 decreases (e.g., Δt₁ decreases), the weight variance Δw₁ may increase, and conversely, as the pre-then-post time 210 increases (e.g., Δt₁ increases), the weight variance Δw₁ may decrease. In an embodiment, the weight variance Δw₁ may decrease to a relatively small value. If a post-spike occurs immediately after a pre-spike is received (e.g., Δt₁ may be relatively small), the correlation between the pre-spike and the post-spike may be determined to be high, and therefore, a weight of a synapse that receives the pre-spike may be strengthened (e.g., Δw may be relatively high).

Like the pre-then-post time 220 of FIG. 2, since a time variance Δt₂ having a negative value corresponds, according to the STDP curve 300, to a weight variance Δw₂ having a negative value, the negative weight variance Δw₂ may be determined based on the pre-then-post time 220. The weight variance Δw₂ may be added to a current weight of a synapse that receives the pre-spike, and thereby, a weight of the synapse may decrease. As shown in the STDP curve 300, firing in a reverse order, such as receiving a pre-spike after the occurrence of post-spike may cause an LTD of a synapse by decreasing a weight of the synapse that receives the pre-spike.

Although FIG. 3 illustrates a particular example of an STDP curve 300 for ease of description, the present disclosure is not limited in this regard. For example, various other STDP curves may be used for determining the weight variance. Depending on the embodiment, a positive time variance in some interval may correspond to a negative weight variance, or vice versa.

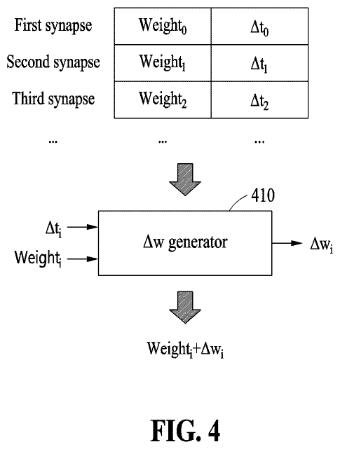

FIG. 4 is a diagram illustrating a learning device of a neuron module, according to an embodiment.

Referring to FIG. 4, a weight variance generator (Δw generator) 410 that determines a weight variance by receiving a weight and a time difference from each synapse connected to a neuron module is illustrated as an example.

The weight variance generator 410 may be and/or may include a device for determining a weight variance of a synapse and may be included in a learning device of a neuron module. The weight variance generator 410 may represent a weight variance generation block.

In an embodiment, the weight variance generator 410 may be implemented using hardware components, software components and/or combinations thereof. For example, the weight variance generator 410 may be implemented using one or more general-purpose or special purpose computers, such as, but not limited to, a processor, a controller, a microprocessor, or any other device capable of responding to and executing instructions in a defined manner. The instructions may include software, such as, but not limited to, a computer program, a piece of code, an instruction, or some combination thereof, to independently or collectively instruct and/or configure the weight variance generator 410 to perform one or more of the operations described with reference to FIG. 4.

The weight variance generator 410 may be connected to a plurality of synapses (e.g., a first synapse, a second synapse, and a third synapse) in one neuron module and may increase area efficiency for learning. The plurality of synapses connected to the neuron module may each have a weight (e.g., a first weight Weight₀, a second weight Weight₁, and a third weight Weight₂, respectively) and may generate and transmit a pre-spike to the neuron module. A timer in the neuron module may determine a time difference (e.g., a first time difference Δt₀, a second time difference Δt₁, and a third time difference Δt₂, respectively) between a post-spike and pre-spike generated in the neuron module.

The weight variance generator 410 may receive a weight Weightᵢ and a time difference Δtᵢ of one of the plurality of synapses and may determine a weight variance Δwᵢ of the synapse, where i is a positive integer greater than zero (0). The weight of the synapse may be updated based on the determined weight variance Δwᵢ. According to an embodiment, the learning device of the neuron module may update the weight of the connected synapse by aggregating a previous weight Weightᵢ and the weight variance Δwᵢ (e.g., Weightᵢ+Δwᵢ).

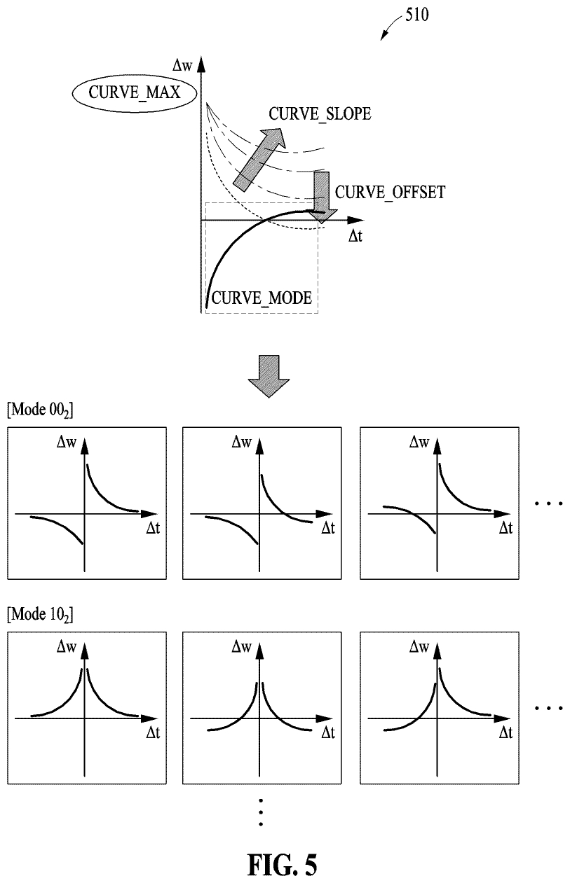

A hyperparameter and a graph for determining a weight variance are described with reference to FIGS. 5 to 13.

FIG. 5 is a diagram illustrating an STDP curve and a hyperparameter, according to an embodiment.

Referring to FIG. 5, an STDP curve 510 and various STDP curves determined based on hyperparameters are illustrated as an example.

The STDP curve 510 may be and/or may include a curve for determining a weight variance of a synapse based on a time difference. The STDP curve 510 may be determined by predetermined hyperparameters. In FIG. 5, although the STDP curve 510 is illustrated as an exponential function for description, the present embodiment is not limited thereto and is shown as a function or a graph having various patterns.

The hyperparameters may represent parameters for determining a maximum value, a slope, or a shape of the STDP curve 510. For example, in the STDP curve 510 of FIG. 5, CURVE_MAX may determine a maximum value of the graph, CURVE_SLOPE may determine a slope of the graph, CURVE_OFFSET may determine an offset of the graph, and CURVE_MODE may determine a shape of the graph. The learning device of the neuron module may determine various graphs based on the predetermined hyperparameters and may determine a weight variance of a synapse based on the determined graph.

In the drawings at the bottom of FIG. 5, below the STDP curve 510, examples of curves generated by different hyperparameters are illustrated. However, the hyperparameters and the STDP curves of FIG. 5 are examples for description. The embodiment is not limited thereto, and various STDP curves may be implemented by various hyperparameters.

When a presynapse is an excitatory synapse, the presynapse may follow an excitatory STDP (eSTDP) curve, and when a presynapse is an inhibitory synapse, the presynapse may follow an inhibitory STDP (iSTDP) curve. The eSTDP curve and the iSTDP curve may be shown as graphs having various patterns depending on whether a neuron is for which part or which portion. As the STDP curve 510 is variously generated depending on the hyperparameters, eSTDP curves and iSTDP curves having various patterns may be implemented.

The hyperparameters are described with reference to FIGS. 7 to 13.

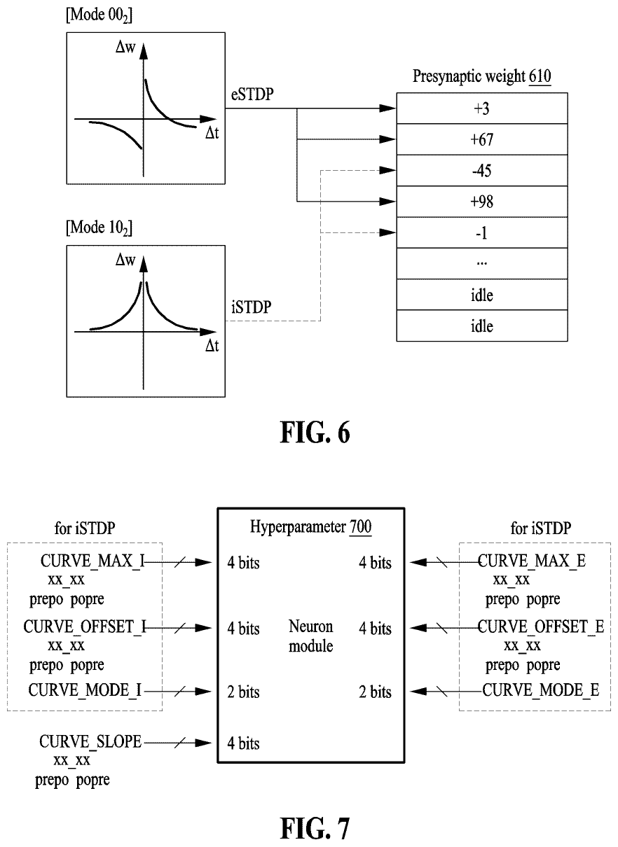

FIG. 6 is a diagram illustrating an operation of applying different STDP curves depending on a weight of a synapse, according to an embodiment.

Referring to FIG. 6, an operation of applying an STDP curve having a different pattern depending on a sign of a presynaptic weight 610 is illustrated as an example. In an embodiment, a weight variance generator 410 in a neuron module may apply curves to eSTDP and iSTDP depending on the sign of the presynaptic weight 610, respectively. In such a manner, a learning device of the neuron module may implement bio-plausible STDP learning by updating a weight through eSTDP if the presynaptic neuron is an excitatory neuron, and updating the weight through iSTDP if the presynaptic neuron is an inhibitory neuron.

That is, as shown in FIG. 6, the learning device of the neuron module may determine a weight variance of the synapse by applying an eSTDP curve when the presynaptic weight 610 is a positive number (e.g., +3, +67, +98), and applying an iSTDP curve when the presynaptic weight 610 is a negative number (e.g., −45, −1).

In FIG. 6, idle may represent an idle state. The idle state may represent a state in which the presynaptic weight 610 is not received from the presynapse.

FIG. 7 is a diagram illustrating hyperparameters, according to an embodiment.

Referring to FIG. 7, a hyperparameter 700 used by a weight variance generator 410 to implement a graph is illustrated as an example. In FIG. 7, four (4) hyperparameters 700 (e.g., CURVE_MAX, CURVE_SLOPE, CURVE_OFFSET, and CURVE_MODE) are illustrated for ease of description, but the present embodiment is not limited thereto and other hyperparameters may be used to implement various graphs.

The graph may include linear graphs respectively included in a plurality of time intervals to implement an exponential STDP curve. The graph may be implemented by the hyperparameter 700.

The hyperparameter 700 may include a first hyperparameter related to a maximum value of the graph, a second hyperparameter related to a reference time interval of the graph, a third hyperparameter related to an offset applied to the graph, and a fourth hyperparameter related to the shape of the graph. In the present disclosure, the first hyperparameter may refer to CURVE_MAX, the second hyperparameter may refer to CURVE_SLOPE, the third hyperparameter may refer to CURVE_OFFSET, and the fourth hyperparameter may refer to CURVE_MODE.

In FIG. 7, CURVE_MAX_I, CURVE_OFFSET_I, and CURVE_MODE_I may be hyperparameters for an iSTDP learning rule, and CURVE_MAX_E, CURVE_OFFSET_E, and CURVE_MODE_E may be hyperparameters for an eSTDP learning rule. That is, the hyperparameter 700 may have a different value depending on whether the hyperparameter 700 is for the iSTDP learning rule or the eSTDP learning rule. CURVE_SLOPE may be used for both iSTDP learning rule and eSTDP learning rule. Depending on the embodiment, CURVE_SLOPE may have a different value depending on the iSTDP learning rule or the eSTDP learning rule.

The number of bits of the hyperparameter 700 may be determined based on the number of bits of the first to fourth hyperparameters. In addition, since iSTDP and eSTDP may each have different graphs in the case of pre-then-post learning and in the case of post-then-pre learning, the number of bits of the hyperparameter 700 may be determined by considering this. In FIG. 7, prepo may represent a bit for pre-then-post learning and popre may represent a bit for post-then-pre learning.

For example, when the first hyperparameter and the third hyperparameter have 4 bits for each of iSTDP and eSTDP, the fourth hyperparameter has 2 bits for each of iSTDP and eSTDP, and the second hyperparameter is universally applied to iSTDP and eSTDP and has 4 bits, the number of bits of the hyperparameter 700 may be determined to be a total of 24 bits.

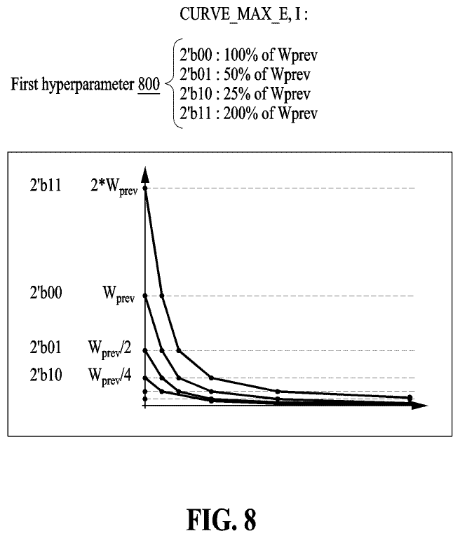

The first to the fourth hyperparameters are described with reference to FIGS. 8 to 14.

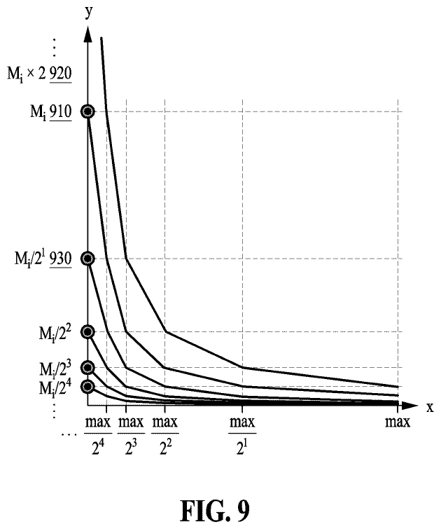

FIGS. 8 and 9 are diagrams illustrating a first hyperparameter, according to an embodiment.

Referring to FIG. 8, a first hyperparameter 800 may be used to determine a maximum value of a graph. That is, a learning device of a neuron module may determine a maximum value or a starting point of the graph through the first hyperparameter 800.

For the bio-plausible STDP, the maximum value of the graph may not be predetermined, but the graph may be determined by reflecting an existing weight value Wₚᵣₑᵥ of a synapse to be learned through the first hyperparameter 800. That is, the learning device of the neuron module may perform weight learning by extracting a weight variance in the unit of [%] of the existing weight value Wₚᵣₑᵥ without using a separate multiplier. For example, as shown in FIG. 8, the learning device of the neuron module may determine one of 200%, 100%, 50%, or 25% of a current weight value to be the first hyperparameter 800 and may use the first hyperparameter 800 as the maximum value of the graph. In this case, CURVE_MAX_E and CURVE_MAX_I as the first hyperparameter 800 may each be configured as 4 bits, which are 2 bits used for determining a maximum value of a pre-then-post learning graph and 2 bits used for determining a maximum value of a post-then-pre learning graph.

Referring to FIG. 9, a graph having a maximum value determined through the first hyperparameter 800 is illustrated as an example. The learning device of the neuron module may have a maximum value of a graph by shifting bits representing a weight Mᵢ 910 of an input synapse based on the first hyperparameter. That is, the maximum value of the graph may be determined to be 2Mᵢ 920 as the maximum value is doubled when shifting bits representing a weight Mᵢ 910 of a synapse to a left side and may be determined to be Mᵢ/2¹ 930 as the maximum value becomes half when shifting the bits to a right side. In addition, depending on the embodiment, the first hyperparameter 800 may be determined to have a value of Mᵢ/2ⁿ or 2ⁿMᵢ (where n is an integer) as the maximum value of the graph by increasing the number of bits of the first hyperparameter 800 and shifting the bits representing the weight Mᵢ 910 of the synapse to the left or right side n times.

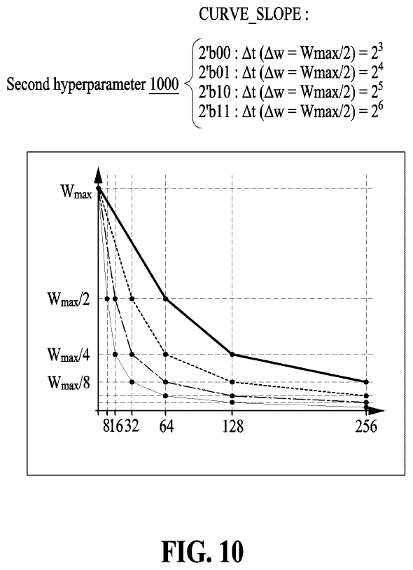

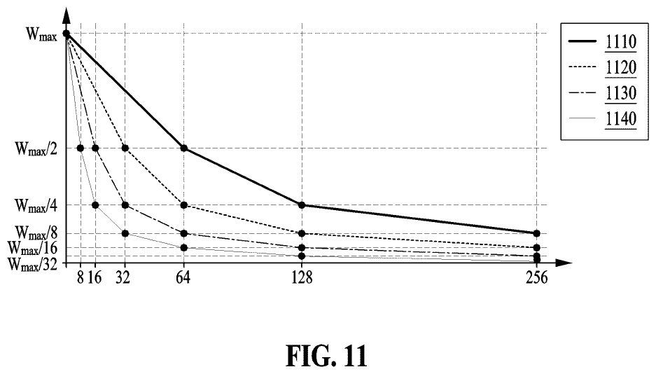

FIGS. 10 and 11 are diagrams illustrating a second hyperparameter, according to an embodiment.

Referring to FIG. 10, a second hyperparameter 1000 may represent a hyperparameter related to a reference time interval. The second hyperparameter 1000 may represent a x coordinate value of an ending point of the reference time interval and may be used to determine a slope of a graph. For example, as shown in FIG. 10, for the second hyperparameter 1000, 2′b00, 2′b01, 2′b10, and 2′b11 may be determined to be 2³, 2⁴, 2⁵, and 2⁶, respectively, and may represent x coordinate values of the ending point of the reference time interval. The reference time interval may be and/or may include a time interval that serves as a reference to distinguish each time interval and may represent a first time interval including a maximum value point. According to an embodiment, the reference time interval may represent an interval from a point where ΔT is 0 to a value in which Wₘₐₓ/2 is satisfied based on a starting value Wₘₐₓ of the graph.

According to an embodiment, the learning device of the neuron module may determine the graph with respect to the reference time interval by linearly connecting the maximum value point of the graph to a point determined by the second hyperparameter 1000. In addition, the learning device of the neuron module may determine bits respectively representing x coordinates of a maximum value point and an ending point of each time interval by shifting bits representing x coordinates of the maximum value point and the ending point of the reference time interval. Thereafter, the learning device of the neuron module may determine a graph with respect to each time interval by linearly connecting the maximum point value and the ending point of each time interval. That is, based on the starting point Wₘₐₓ of the graph determined by CURVE_MAX, if a AT value where Wₘₐₓ/2 is satisfied is determined by CURVE_SLOPE, a slope of the graph may be adjusted as shown in FIG. 10.

Referring to FIG. 11, graphs determined by various second hyperparameters 1000 are illustrated as an example. A graph 1110 may be and/or may include a graph determined when CURVE_SLOPE is 2′b11 and 64, a graph 1120 may be and/or may include a graph determined when CURVE_SLOPE is 2′b10 and 32, a graph 1130 may be and/or may include a graph determined when CURVE_SLOPE is 2′b01 and 16, and a graph 1140 may be and/or may include a graph determined when CURVE_SLOPE is 2′b00 and 8.

In the graphs, both horizontal axis (ΔT) and vertical axis (ΔW) intervals may be divided into log scales. That is, in the graphs, each interval divided into log scales may be determined by shifting a bit from maximum values of the horizontal and vertical axes. In this case, the divided horizontal axis interval may represent a time interval of the graph and the vertical axis interval may represent a weight variance interval according to each time interval. For example, as shown in FIG. 11, in the graphs, when a starting value of the graph determined by CURVE_MAX is Wₘₐₓ, ΔW may be reduced by half at each time interval of ΔT starting from Wₘₐₓ.

In addition, the number of time intervals may be determined based on the second hyperparameter related to the reference time interval and the number of bits of the time difference. The learning device of the neuron module may adjust the number of time intervals by determining ΔT where ΔW is Wₘₐₓ/2. For example, as shown in FIG. 11, in a case where a total time window is 256 time steps, the learning device of the neuron module may adjust the number of time intervals to 6, 5, 4, and 3 by determining AT, where ΔW is Wₘₐₓ/2, to be 8, 16, 32, 64, respectively.

The learning device of the neuron module may adjust the slope of the graph by adjusting the number of time intervals. For example, the available number of time intervals may be selected by setting CURVE_SLOPE to 2 bits and the slope may be determined based on the number of time intervals.

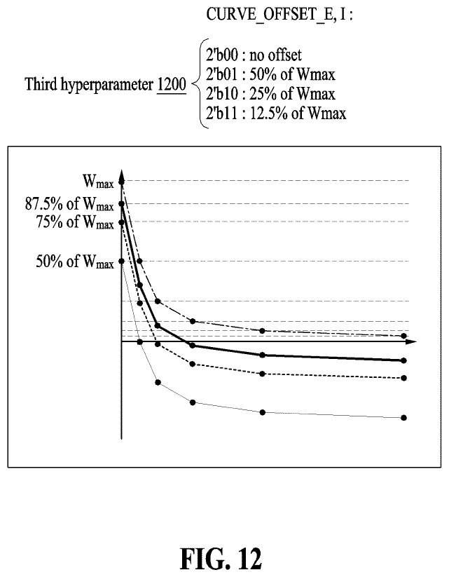

FIG. 12 is a diagram illustrating a third hyperparameter, according to an embodiment.

Referring to FIG. 12, a third hyperparameter 1200 may represent a hyperparameter related to an offset applied to a graph. The learning device of the neuron module may implement a graph in the case where both LTP and LTD exist in ΔT with a predetermined sign, through the third hyperparameter 1200. For example, as shown in FIG. 12, the third hyperparameter 1200 may be used to implement a graph that may have both a positive value and a negative value of a weight variance depending on the size of ΔT during pre-then-post or post-then-pre learning.

The third hyperparameter 1200 may determine an offset based on a maximum value of the graph. For example, the learning device of the neuron module may select one from values of 0%, 50%, 25%, or 12.5% based on Wₘₐₓ to be the third hyperparameter 1200 and may use the value as an offset. To not apply an offset to the graph, the third hyperparameter 1200 may be determined to be 0%.

The learning device of the neuron module may adjust a weight variance by an offset based on the third hyperparameter 1200. The learning device of the neuron module may adjust the weight variance by adding or subtracting the offset determined by the third hyperparameter 1200 to or from the weight variance. The offset may be determined by shifting bits representing a maximum value of the graph by a predetermined amount determined by the third hyperparameter 1200.

For example, as shown in FIG. 12, with respect to the third hyperparameter 1200, 2′b00 may be determined to be 0% based on the maximum value of the graph, 2′b01 may be determined to be 50%, 2′b10 may be determined to be 25%, and 2′b11 may be determined to be 12.5%, and each may represent an offset to be applied to the weight variance. Through the third hyperparameter 1200, the learning device of the neuron module may implement graphs having different offsets as shown in FIG. 12.

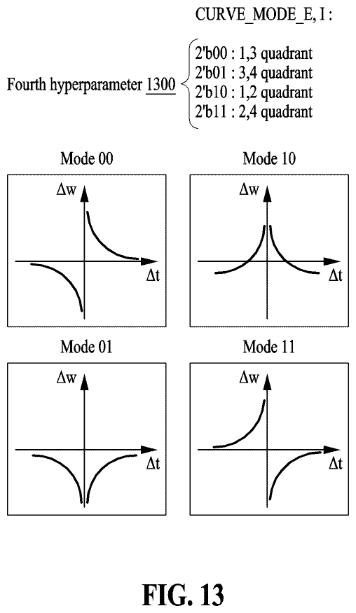

FIG. 13 is a diagram illustrating a fourth hyperparameter, according to an embodiment.

Referring to FIG. 13, a fourth hyperparameter 1300 may represent a parameter related to a shape of a graph. The fourth hyperparameter 1300 may be used to determine a pattern of the graph according to a learning rule. For example, the fourth hyperparameter 1300 may use CURVE_MODE_E for determining a pattern of a graph for eSTDP and CURVE_MODE_I for determining a pattern of a graph for iSTDP as 2-bit hyperparameters.

According to an embodiment, the fourth hyperparameter 1300 may represent a position on a quadrant of the graph according to eSTDP and iSTDP. For example, as shown in FIG. 13, for the fourth hyperparameter 1300, 2′b00 may be determined to be the first and fourth quadrants, 2′b01 may be determined to be the third and fourth quadrants, 2′b10 may be determined to be the first and second quadrants, and 2′b11 may be determined to be the second and fourth quadrants, and thereby, the learning device of the neuron module may implement graphs having patterns of Mode 00, Mode 01, Mode 10, and Mode 11, respectively.

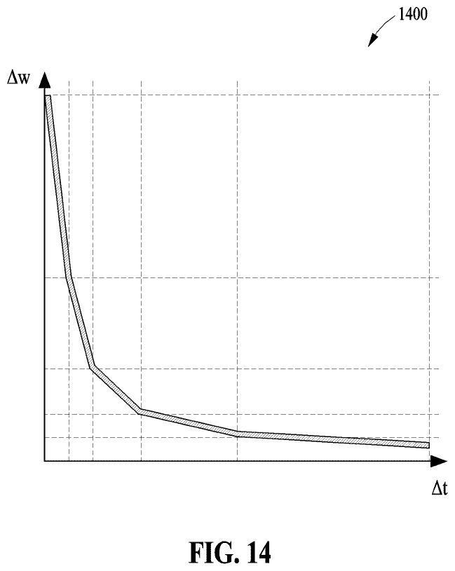

FIG. 14 is a diagram illustrating a graph, according to an embodiment.

The learning device of the neuron module may determine a graph 1400 using piece-wise linear scheme for an STDP curve to reduce the number of required cycles for an operation. The learning device of the neuron module may similarly implement the shape of a biological STDP curve by using the number of limited bits through the piece-wise linear scheme. However, the present embodiment is not limited to the implementation of an STDP curve and may be used in various fields requiring an exponential curve.

By implementing an exponential curve using the piece-wise linear scheme, the learning device of the neuron module may reduce the number of required cycles to determine ΔW by using cycles by as many as the number of bits of a maximum value (e.g., a time window) of AT. In addition, since only one weight variance generation block is mounted on the neuron module rather than implementing the weight variance generation block one by one for each synapse, an area may be reduced and a plurality of synapses may be freely connected, and thereby, the synapse scalability may increase.

In the present disclosure, for ease of description, the graph may refer to a piece-wise linear curve and each time interval may refer to each piece of the graph.

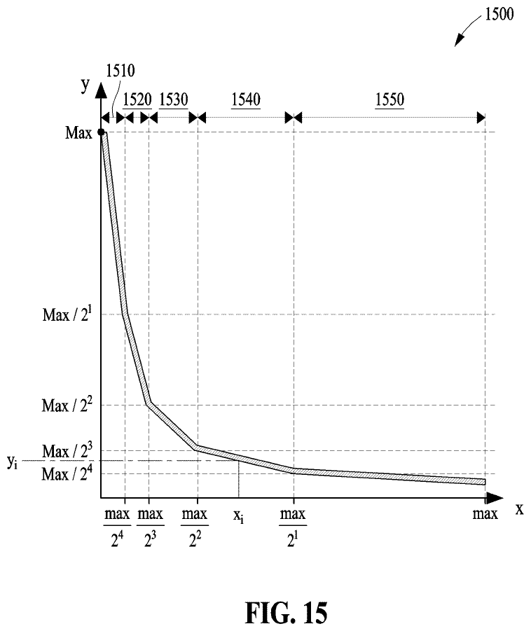

FIG. 15 is a diagram illustrating a time interval of a graph, according to an embodiment.

Referring to FIG. 15, a graph 1500 may include a linear graph included in each of a plurality of time intervals. According to an embodiment, each time interval and a weight variance interval per time interval may be determined based on points where maximum values of the x-axis and γ-axis satisfy ½, ½², ½³, and ½⁴, depending on the number of time intervals. Through this, when the learning device of the neuron module determines the graph 1500, each time interval and the weight variance interval per time interval may be determined using a shifter, and thus, spatial efficiency may increase and the number of required cycles for implementing the graph may be reduced. In the present disclosure, for ease of description, a first time interval 1510 may be referred to as time interval 0, a second time interval 1520 may be referred to as time interval 1, a third time interval 1530 may be referred to as time interval 2, a fourth time interval 1540 may be referred to as time interval 3, and a fifth time interval 1550 may be referred to as time interval 4. That is, time interval v may be referred to as a (v+1)-th time interval from a side close to zero (0) on the x-axis of the graph.

For example, as shown in FIG. 15, the number of time intervals may be determined to be five (5), which are the plurality of first to fifth time intervals 1510 to 1550, by using 1/24 of a maximum value max representing a time difference on the x-axis as the second hyperparameter. In this case, each time interval may be determined by shifting bits representing a maximum value Max on the y-axis and the maximum value max on the x-axis to the right side. A y value corresponding to a minimum value on the x-axis of the time interval v may be determined to be a value obtained by dividing Max by 2^{v}. That is, the graph of the time interval 1510 may be determined by linearly connecting a weight variance interval [Max, Max/2) for a time interval [0, max/2⁴), and the graph of the next time interval 1520 may be determined by linearly connecting a weight variance interval [Max/2, Max/2²) for a time interval [max/2⁴, max/2³). However, although each time interval and a weight variance interval are determined by shifting bits representing maximum values of each axis to the right side by one bit in FIG. 15, the present embodiment is not limited thereto, and the time interval and weight variance interval may be determined by shifting one or more bits.

In FIG. 15, xᵢ may represent a time difference between an input post-spike and a pre-spike, and yᵢ may represent a weight variance of a synapse corresponding to a time interval determined based on a graph. In addition, when the number of bits representing xᵢ is k, a maximum value max on the x-axis may be determined to be 2^{k+1}. For example, when a time window is 100, since k is six (6), max may be determined to be 128.

The number of time intervals may be adjustable by the second hyperparameter, but the number of time intervals may be limited up to k+1 due to k. For example, when k is four (4) bits, the number of time intervals may be up to five (5).

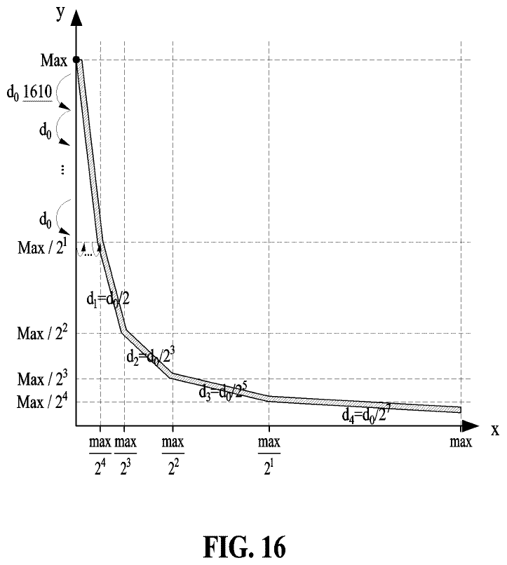

The weight variance of a synapse corresponding to the time difference between the post-spike and the pre-spike may be determined based on a reference decrease and the maximum value of the graph. An operation of determining a weight variance is described with reference to FIGS. 16 to 31.

FIG. 16 is a diagram illustrating a decrease in each time interval, according to an embodiment.

Referring to FIG. 16, in a graph of a case in which a time interval is divided into five (5), a reference decrease d₀ 1610 of a graph with respect to a reference time interval and a decrease dᵥ with respect to a time interval v are exemplarily illustrated.

The decrease with respect to a time interval may represent a degree of a change in a y value as an x value increases by one (1) in the time interval. The reference decrease 1610 may represent a degree of a change in the y value as the x value increases by 1 in the reference time interval. For example, in the graph of FIG. 16, the reference decrease d₀ 1610 may be a value satisfying Max/2 by decreasing Max max/2⁴ times.

In each time interval, a line segment of the graph may be determined according to the recurrence relation of the arithmetic sequence, aₙ=aₙ₋₁+d. A common difference d in the recurrence relation of the arithmetic sequence may be differently determined according to each time interval. In this case, the common difference d of each time interval may represent a decrease in each time interval.

The learning device of the neuron module may determine the reference decrease 1610 do based on the maximum value Wₘₐₓ of the graph and the second hyperparameter CURVE_SLOPE as Equation 1 below.

$${d}_{0} = \frac{{W}_{max}}{{2}^{( 1 + curve\_slope )}} \qquad [ Equation 1 ]$$

Referring to Equation 1, curve_slope may represent log₂ CURVE_SLOPE. For example, when CURVE_SLOPE is 16 (e.g., CURVE_SLOPE=16) in FIG. 16, the reference decrease 1610 may be determined to be Max/2⁵.

The learning device of the neuron module may determine a decrease with respect to each time interval based on the reference decrease 1610. For example, as shown in FIG. 16, when the reference decrease is d₀ and each time interval and a weight variance interval according to the time interval are determined, it may be determined that a decrease with respect to time interval 1 is d₁=d₀/2, a decrease with respect to time interval 2 is d₂=d₀/2³, a decrease with respect to time interval 3 is d₃=d₀/2⁵, and a decrease with respect to time interval 4 is d₄=d₀/2⁷. That is, a decrease dᵥ for time interval v may be expressed by Equation 2 shown below.

$${d}_{v} = \frac{{d}_{0}}{{2}^{( 2 v - 1 )}} , where v > 0 \qquad [ Equation 2 ]$$

According to aₙ embodiment, the learning device of the neuron module may determine a decrease with respect to each time interval by shifting bits representing the reference decrease d₀ 1610. The learning device of the neuron module may easily determine the decrease with respect to each time interval using the reference decrease d₀ 1610 without storing a value of a decrease that needs to be differently applied to each time interval. Through this, the learning device of the neuron module may improve the spatial efficiency using a shifter. For example, in FIG. 16, since the decrease with respect to time interval 1 is d₁=d₀/2, the decrease with respect to time interval 1 may be determined by shifting the bits representing the reference decrease d₀ 1610 to the right side once. For example, in FIG. 16, since the decrease with respect to the time interval 2 is d₂=d₀/2³, the decrease with respect to the time interval 2 may be determined by shifting the bits representing the reference decrease d₀ 1610 to the right side three (3) times. The decrease dᵥ with respect to time interval v may be expressed by Equation 3 to use the shifter.

$${d}_{v} = \{ \begin{matrix}\frac{2 {d}_{0}}{{2}^{2 v}} & , & v \geq 1 \\ {d}_{0} & , & v = 0\end{matrix} \qquad [ Equation 3 ]$$

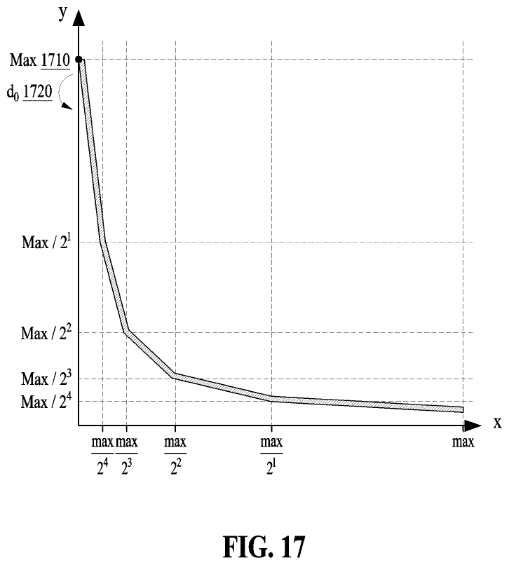

FIG. 17 is a diagram illustrating a maximum value and a reference decrease of a graph, according to aₙ embodiment.

Referring to FIG. 17, a curve generator in the learning device of the neuron module may receive a maximum value Max 1710 of a graph and may determine a reference decrease d₀ 1720 to generate the graph.

The curve generator may determine the graph for updating a weight of one of a plurality of synapses connected to the neuron module in a spiking neural network, based on the maximum value Max 1710 and the reference decrease d₀ 1720 of the graph.

The determining of the reference decrease d₀ 1720 and the graph of FIG. 17 may be similar in many respects to the operations described above with reference to FIG. 16, and may include additional features not mentioned above. Consequently, repeated descriptions thereof may be omitted for the sake of brevity.

In the present disclosure, the curve generator may be referred to as a piece-wise curve generator for ease of description.

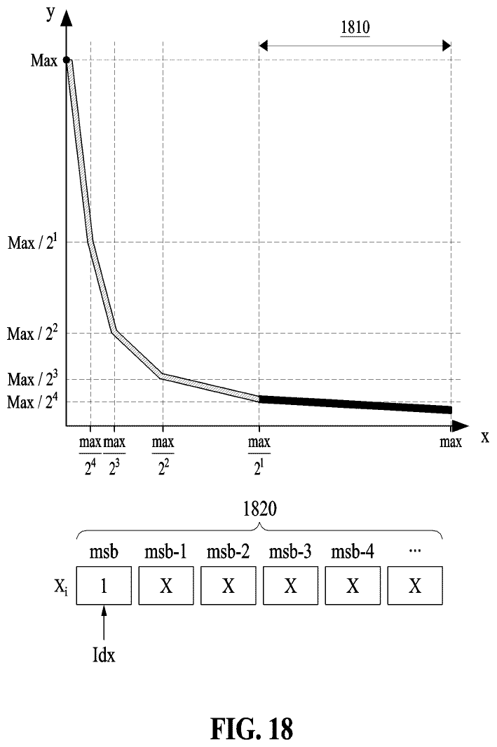

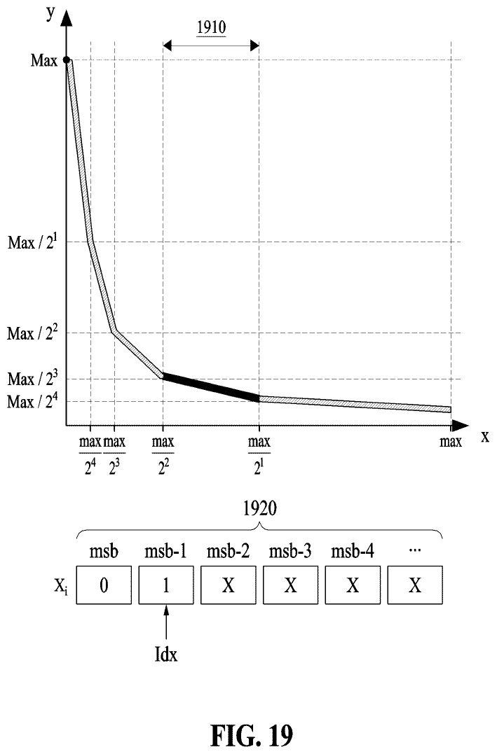

FIGS. 18 and 19 are diagrams illustrating an operation of determining a target time interval, according to an embodiment.

The target time interval may be a time interval, which may include a time difference between a post-spike occurring in the neuron module and a pre-spike occurring in a synapse, of a plurality of time intervals of a graph.

Referring to FIG. 18, operations of searching for bits 1820 representing a time difference and searching for a target time interval 1810 are exemplarily illustrated.

The learning device of the neuron module may sequentially search for a first value from a most significant bit (MSB) of the bits 1820 representing the time difference, and may determine the target time interval from the plurality of time intervals using an index in which the first value is initially found. The target time interval may be determined to be a time interval that is farther from the x-axis in the graph as the value in which the first value is initially found is closer to the MSB. That is, the learning device of the neuron module may sequentially search for the first value from the MSB of the bits 1820 representing the time difference and may determine the target time interval in reverse order from the last time interval including a maximum value on the x-axis in the graph. The first value may be, for example, one (1).

For example, as shown in FIG. 18, when the first value is initially found in the MSB, the target time interval 1810 may be determined to be a time interval that satisfies [max/2, max) on the x-axis.

In the present disclosure, an index may be referred to as idx for ease of description.

Referring to FIG. 19, a case in which the first value is initially found in a following bit of an MSB of bits 1920 representing a time difference is exemplarily illustrated. As shown in FIG. 19, when the first value is initially found in the following bit of the MSB, a target time interval 1910 may be determined to be [max/2², max/2¹).

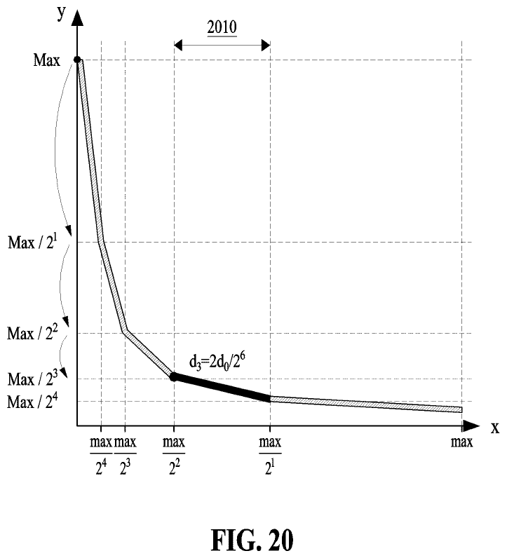

FIG. 20 is a diagram illustrating an operation of determining a target decrease for a target time interval, according to an embodiment.

Referring to FIG. 20, the learning device of the neuron module may determine a target decrease of a graph with respect to a determined target time interval 2010. In FIG. 20, an example in which the number of time intervals is five (5) and the target time interval 2010 is time interval 3 is illustrated. However, the present disclosure is not limited in this regard, and the number of time intervals and/or the location of the target time interval may vary without departing from the scope of the present disclosure.

The learning device of the neuron module may determine a target decrease by shifting bits representing a reference decrease d₀ based on an index in which the first value is initially found. For example, since a target decrease d₃ is determined to be 2d₀/2⁶ in FIG. 20, the target decrease d₃ may be determined by shifting bits representing 2d₀ to the right side six (6) times.

In addition, the learning device of the neuron module may determine a maximum value of the target time interval 2010 by shifting bits representing a maximum value of the graph based on the index in which the first value is initially found. For example, since the maximum value of the target time interval 2010 is determined to be Max/2³ in FIG. 20, the maximum value of the target time interval 2010 may be determined by shifting the bits representing the maximum value of the graph to the right side three (3) times through a shifter.

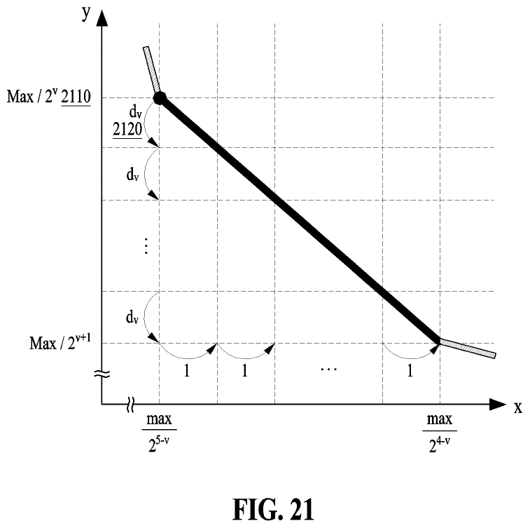

FIG. 21 is a diagram illustrating a maximum value of each time interval and a decrease in each time interval, according to an embodiment.

Referring to FIG. 21, an example in which time interval v is determined to be a target time interval when the number of time intervals is five (5) is illustrated by generalizing the case of FIG. 20. The learning device of the neuron module may determine a maximum value 2110 of the target time interval to be Max/2^{v}, and may determine a target decrease with respect to the target time interval through Equation 3.

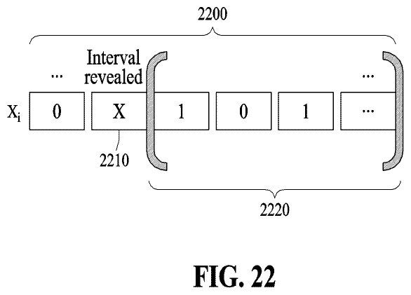

FIG. 22 is a diagram illustrating an operation of finding a first value, according to an embodiment.

Referring to FIG. 22, a bit 2210 may be initially found from among bits 2200 representing a time difference between a post-spike and a pre-spike, in which the bit 2210 is a first value for obtaining a target time interval, and bits 2220 may be bits after an index in which the first value is initially found.

The learning device of the neuron module may determine a weight variance of a synapse using a target decrease and indices in which the first value is found after the index in which the first value is initially found among the bits 2220 representing the time difference. According to an embodiment, the learning device of the neuron module may implement bit-weighted decreasing using a shifter without using a multiplier. In addition, the learning device of the neuron module may search for the first value bit-by-bit by using the idx to determine the target time interval without modification.

The learning device of the neuron module may determine a decrease in each index by shifting bits representing a target decrease by each index with respect to the indices in which the first value is found and may determine a weight variance of a synapse by subtracting the decrease in each index from a maximum value of the target time interval. The decrease in an index may represent a degree of a decrease in a graph value due to the index. In the present disclosure, the decrease of each index may be referred to as a partial difference of an index for ease of description.

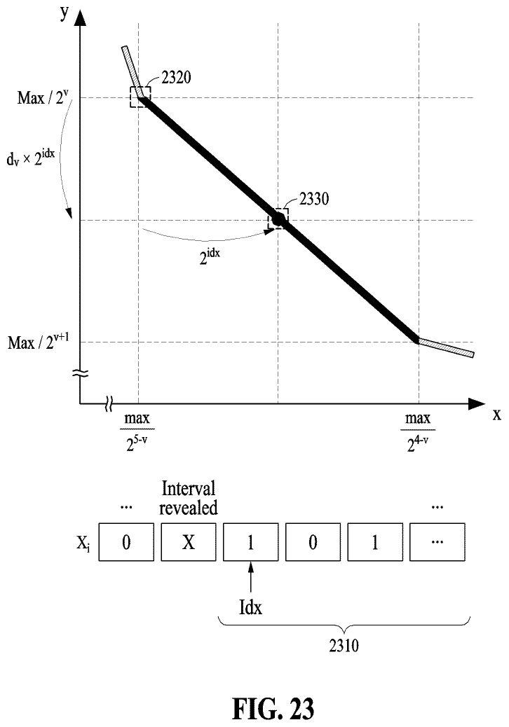

The determining of a variance of a synaptic weight is described with reference to FIGS. 23 to 25.

FIGS. 23 to 25 are diagrams illustrating an operation of determining a weight variance using indices with found first values, according to an embodiment.

In FIGS. 23 to 25, a case in which a bit having a value of (1, 0, 1) is found after a first value is initially found is illustrated. However, the present disclosure is not limited in this regard, and other bit values may be found after the first value without departing from the scope of the present disclosure.

Referring to FIG. 23, when the first value is found among bits 2310 after a bit in which the first value is initially found, the learning device of the neuron module may determine a decrease of a searched index idx. The decrease in the index may be determined by Equation 4 shown below using a target decrease −dᵥ and an index value idx.

$$- {d}_{v} \times {2}^{idx} \qquad [ Equation 4 ]$$

Referring to Equation 4, 2^{idx} may represent a distance of a second point 2330 from a starting point of the target time interval (e.g., first point 2320). Accordingly, since “1” is found in idx, the learning device of the neuron module may determine the second point 2330 by reducing a first point 2320 representing a maximum value of the target time interval by the decrease in the index.

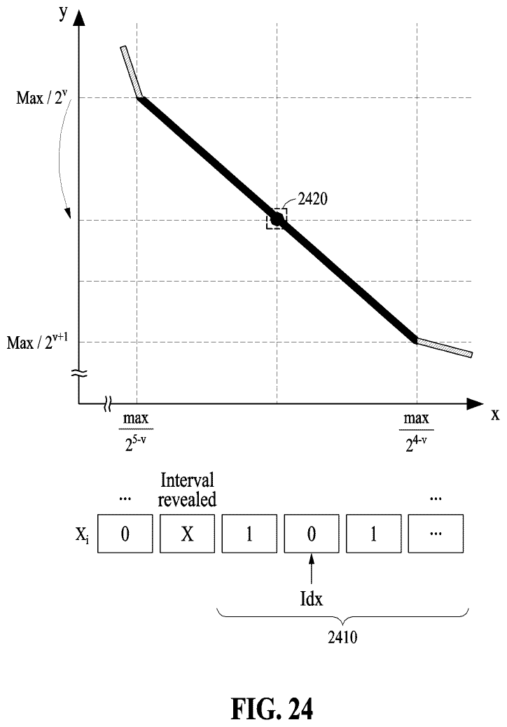

Referring to FIG. 24, when a bit that is not the first value is found in a subsequent index, the learning device of the neuron module may not perform a reduction by the decrease in the index. That is, when a bit (e.g., “0”) that is not the first value is found among bits 2410 after the bit in which the first value is initially found, a corresponding bit may be skipped and a next bit may be searched without modifying a third point 2420.

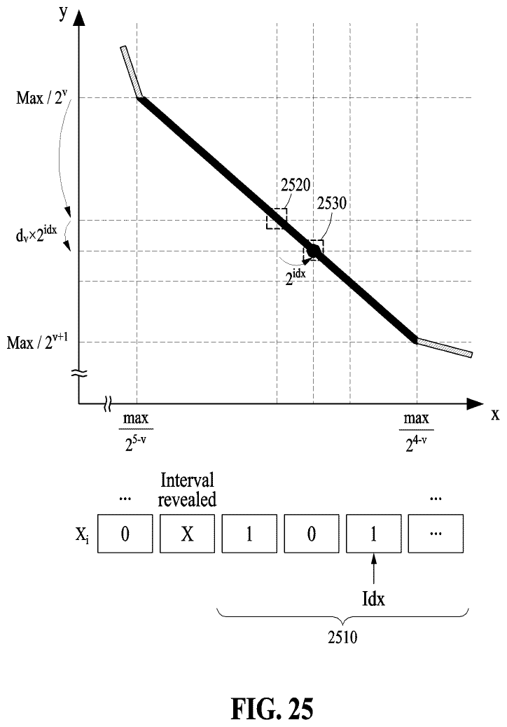

Referring to FIG. 25, when the first value is found in a subsequent index again, the learning device of the neuron module may perform a reduction again by the decrease in the corresponding index. The learning device of the neuron module may determine a fourth point 2530 by reducing a third point 2520 determined by the previous reduction by a decrease in the index in which the first value is found.

The learning device of the neuron module may iteratively perform the operation of searching for the first value until the least significant bit (LSB). Alternatively, depending on the embodiment, the operation of searching for the first value may be iteratively performed until the desired resolution. In such a manner, the learning device of the neuron module may determine the weight variance corresponding to the time difference in the graph.

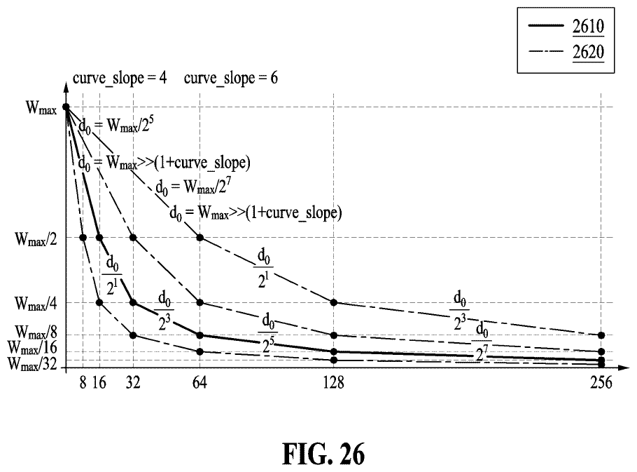

FIG. 26 is a diagram illustrating a decrease in a graph according to a second hyperparameter, according to an embodiment.

Referring to FIG. 26, first graph 2610 and second graph 2620 may be determined with respect to different second hyperparameters and a decrease in each time interval of each graph. The determining of the first and second graphs 2610 and 2620 and the determining a decrease in each time interval may be similar in many respects to the operations described above with reference to FIGS. 14 to 25, and may include additional features not mentioned above. Consequently, repeated descriptions thereof may be omitted for the sake of brevity.

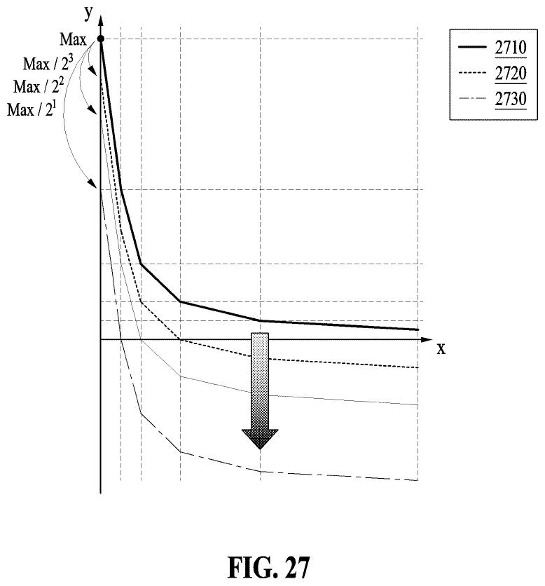

FIG. 27 is a diagram illustrating an offset applied to a graph, according to an embodiment.

Referring to FIG. 27, the learning device of the neuron module may adjust a weight variance by an offset based on a third hyperparameter related to the offset applied to a graph. That is, the learning device of the neuron module may output a value determined through a graph 2710 as a weight variance according to the third hyperparameter or may output the value by adjusting the value by an offset.

For example, as shown in FIG. 27, when the third hyperparameter is 2³, a value determined through the first graph 2710 may be determined to be a weight variance by reducing the value by Max/2³ as shown in a second graph 2720, and when the third hyperparameter is 2, the value may be determined to be a weight variance by reducing the value by Max/2 as shown in a third graph 2730.

The learning device of the neuron module may implement a graph by approximating biological STDP curves having more various shapes by determining a weight variance using an offset. In addition, the learning device of the neuron module may reproduce biological STDP curves having more various shapes by differently setting offsets depending on a sign of AT.

In addition, the learning device of the neuron module may differently set an offset depending on a sign of a weight, may reflect a biological feature of a synapse, and may differently implement a graph of an excitatory synapse having a positive weight and a graph of an inhibitory synapse having a negative weight.

According to an embodiment, the learning device of the neuron module may determine a weight variance to be “0” for a time difference exceeding a predetermined range, and thereby, may reflect the characteristic of an STDP curve that a y value converges to zero (0) when an absolute value of an x value is relatively large.

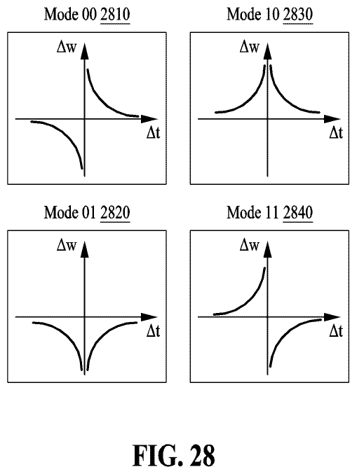

FIG. 28 is a diagram illustrating a mode of a graph, according to an embodiment.

Referring to FIG. 28, the learning device of the neuron module may determine a sign of a weight variance depending on a sign of a time difference based on a fourth hyperparameter related to a shape of a graph. A mode may represent a shape of a graph that determines a sign of a weight variance according to a sign of a time difference.

For example, a first mode 00 2810 may represent that a graph is determined based on the first and fourth quadrants, a second mode 01 2820 may represent that a graph is determined based on the third and fourth quadrants, a third mode 10 2830 may represent that a graph is determined based on the first and third quadrants, and a fourth mode 11 2840 may represent that a graph is determined based on the second and fourth quadrants. Although four (4) patterns and types of graphs shown by modes are illustrated for description in FIG. 28, the present embodiment is not limited thereto and various graphs with patterns may be plausible based on the fourth hyperparameter.

In addition, to describe a mode, FIG. 28 illustrates that a sign of one weight variance is determined according to a sign of a time difference. However, the embodiment is not limited thereto, and both negative and positive weight variance signs may be determined in a sign of one time difference by adding an offset or noise.

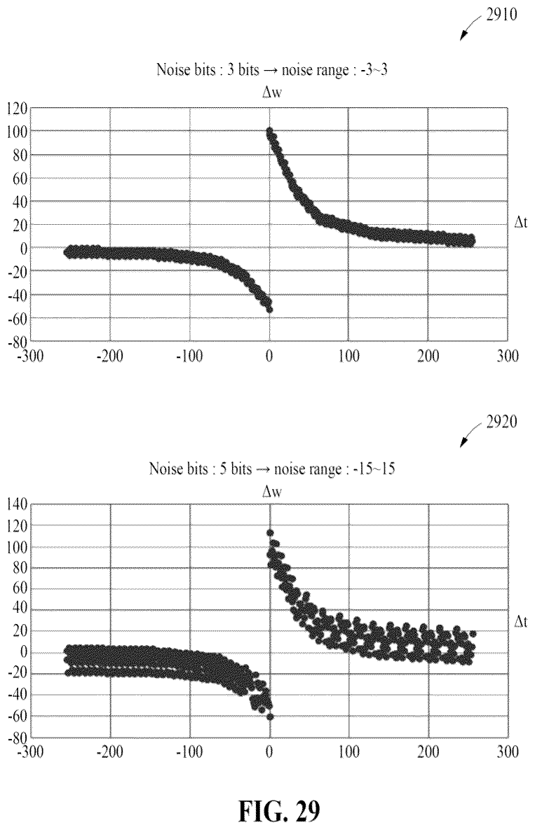

FIG. 29 is a diagram illustrating noise, according to an embodiment.

Referring to FIG. 29, a first graph 2910 and a second graph 2920 with added noise are exemplarily illustrated. The learning device of the neuron module may add noise to a weight variance by applying a random number to the weight variance. That is, the learning device of the neuron module may output a determined weight variance without modification according to the embodiment or may output an adjusted value by adding random noise as the weight variance. The noise may be added through, for example, a linear feedback shift register (LFSR).

The noise may have a noise bit and a noise range of different numbers of bits depending on the embodiment. For example, in FIG. 29, the first graph 2910 may be an example in which noise from −3 to 3 is added through a 3-bit noise bit, and the second graph 2920 may be an example in which noise from −15 to 15 is added through a 5-bit noise bit.

By adding the noise, the learning device of the neuron module may provide randomness to learning of the neuron module like the actual biological STDP learning, and may escape from a local minimum in a learning process. In addition, since the STDP learning is granted regardless of a synapse type in a biological neural network, the learning device of the neuron module may add noise of the same range to the graph regardless of the sign of the time difference or the sign of the weight depending on the embodiment.

According to an embodiment, to simulate a feature that a real biological synapse does not change the excitatory and inhibitory characteristics, when an existing weight Wₚᵣₑᵥ is a positive number (e.g., in the case of an excitatory synapse), a weight variance generator may clamp a minimum value to one (1), and when Wₚᵣₑᵥ is a negative number (e.g., in the case of an inhibitory synapse), the weight variance generator may clamp a maximum value to −1.

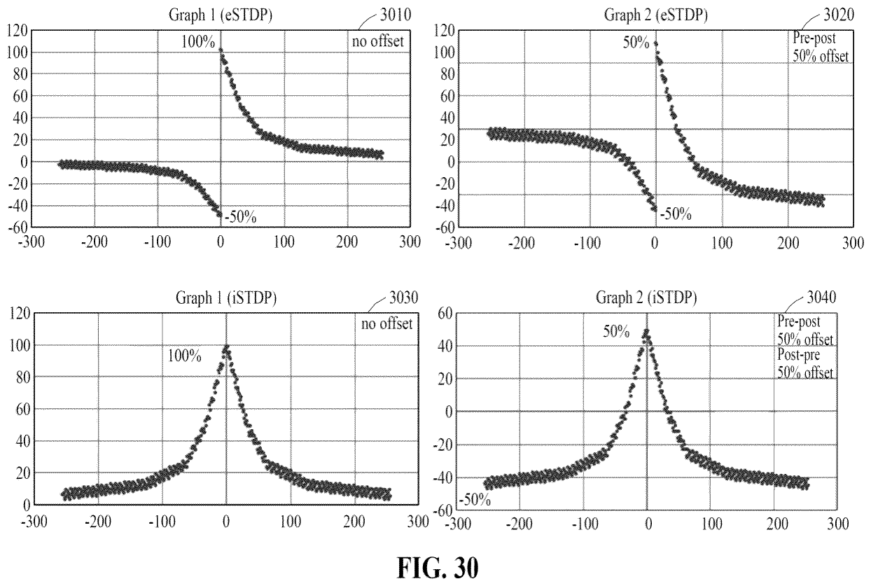

FIG. 30 is a diagram illustrating an example of a graph to which an offset, a mode, and noise are applied, according to an embodiment.

Referring to FIG. 30, graphs (e.g., a first graph 3010, a second graph 3020, a third graph 3030, and a fourth graph 3040) determined through the processes described above by applying different offsets, modes, and noises depending on different hyperparameters are exemplarily illustrated.

In FIG. 30, the first graph 3010 and the second graph 3020 for eSTDP learning may respectively represent a case in which an offset is zero (0) and a case in which an offset for pre-then-post learning is 50% of a maximum value, and the third graph 3030 and the fourth graph 3040 for iSTDP learning may respectively represent a case in which an offset is zero (0) and a case in which offsets for pre-then-post learning and post-then-pre learning are 50% of a maximum value.

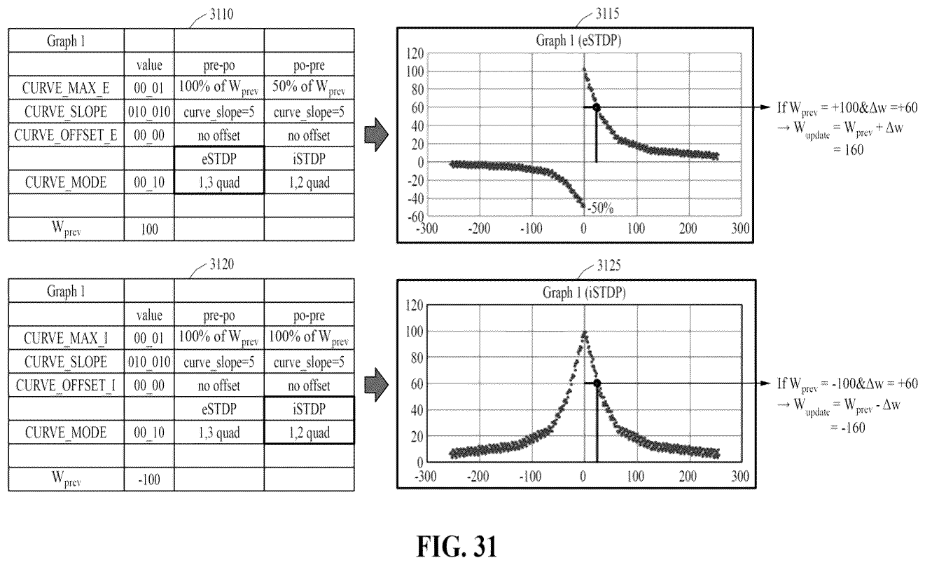

FIG. 31 is a diagram illustrating an operation of updating a weight based on a weight variance, according to an embodiment.

Referring to FIG. 31, a process of determining a first graph 3115 and a second graph 3125 according to a first hyperparameter 3110 and a second hyperparameter 3120, respectively, and a process of updating a synaptic weight based on a synaptic weight variance determined through the first and second graphs 3115 and 3125 are exemplarily illustrated.

For example, in FIG. 31, the learning device of the neuron module may generate the first graph 3115 according to the first hyperparameter 3110. Since an existing synaptic weight is +100 and an eSTDP learning rule is applied, the first graph 3115 may be determined using hyperparameters with respect to eSTDP among the first hyperparameter 3110. If a weight variance corresponding to a time difference between a post-spike and a pre-spike determined based on the first graph 3115 is +60, the learning device of the neuron module may update the synaptic weight to 160 by aggregating the existing synaptic weight and the weight variance to strengthen the excitatory characteristic (e.g., W_{update}=Wₚᵣₑᵥ+Δw=160).

As another example, the learning device of the neuron module may generate the second graph 3125 according to the second hyperparameter 3120. Since an existing synaptic weight is −100 and an iSTDP learning rule is applied, the graph 3125 may be determined using hyperparameters with respect to iSTDP among the second hyperparameter 3120. If a weight variance corresponding to a time difference between a post-spike and a pre-spike determined based on the second graph 3125 is +60, the learning device of the neuron module may update the synaptic weight to −160 by reducing the existing synaptic weight and the weight variance to strengthen the inhibitory characteristic (e.g., W_{update}=Wₚᵣₑᵥ−Δw=−160).

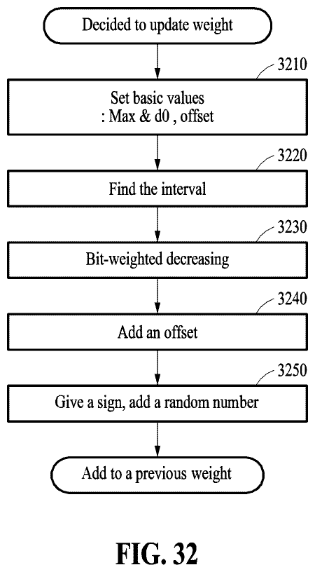

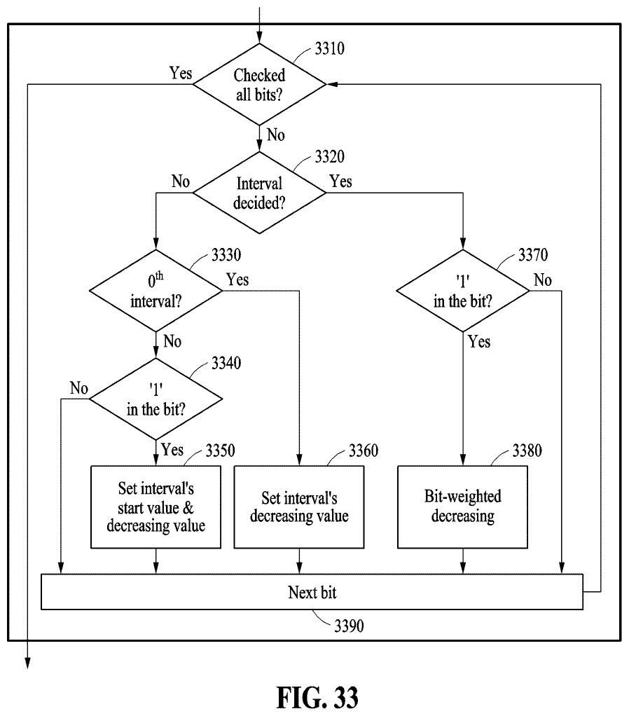

FIGS. 32 and 33 are flowcharts illustrating an operation of a learning device of a neuron module to determine a weight variance, according to an embodiment.

Referring to FIG. 32, operations for determining a weight variance may be sequentially illustrated.

In operation 3210, the learning device of the neuron module may determine a maximum value of a graph and a reference decrease with respect to a reference time interval based on hyperparameters to determine the graph. In operation 3210, one cycle may be consumed.

In operation 3220, the learning device of the neuron module may determine a target time interval including a time difference between a post-spike and a pre-spike among a plurality of time intervals of the graph, based on the maximum value and the reference decrease of the graph. The target time interval may be determined based on an index in which a first value is initially found by sequentially searching for bits representing the time difference.

In operation 3230, the learning device of the neuron module may determine a weight variance of a synapse corresponding to the time difference by determining a maximum value of the target time interval and a target decrease. The learning device of the neuron module may determine the weight variance by sequentially searching for bits after the index in which the first value is initially found among the bits representing the time difference. The weight variance may be determined by a decrease in the index in which the first value is found. In operations 3220 and 3230, as many cycles as the number of bits representing a total time difference may be consumed. When the target time interval is time interval 0, the number of cycles may be consumed, wherein the number is obtained by adding one (1) to the number of bits representing the total time difference.

In operation 3240, the learning device of the neuron module may apply an offset to the determined weight variance. In operation 3240, one cycle may be consumed.

In operation 3250, the learning device of the neuron module may determine a sign of the weight variance and may add random noise. In operation 3250, one cycle may be consumed.

Referring to FIG. 33, detailed operations related to operations 3220 and 3230 of FIG. 32 are illustrated.

In operation 3310, the learning device of the neuron module may determine whether all bits representing a time difference between a post-spike and a pre-spike are searched. When all bits are searched, a determined weight variance may be output.

In operation 3320, when all bits are not searched, the learning device of the neuron module may determine whether a target time interval is determined. That is, the learning device of the neuron module may determine whether the first value is searched for more than once in the bits.

In operation 3330, when the target time interval is not determined, the learning device of the neuron module may determine whether a currently searched index is a bit corresponding to time interval 0. That is, the learning device of the neuron module may determine whether the currently searched index corresponds to an LSB.

In operation 3340, when the currently searched index is not the bit corresponding to time interval 0, the learning device of the neuron module may determine whether the bit of the currently searched index is the first value.

In operation 3350, when the bit of the currently searched index is the first value, the learning device of the neuron module may determine a time interval corresponding to the currently searched index to be the target time interval. In addition, the learning device of the neuron module may determine a maximum value of the target time interval and a target decrease.

In operation 3360, when the currently searched index is the bit corresponding to time interval 0, the learning device of the neuron module may determine a reference time interval to be the target time interval. The learning device of the neuron module may determine the maximum value of the graph and the reference decrease to be the maximum value of the target time interval and the target decrease.

In operation 3370, when the target time interval is determined, the learning device of the neuron module may determine whether the bit of the currently searched index is the first value.

In operation 3380, when the bit of the currently searched index is the first value, the learning device of the neuron module may perform a reduction by determining a decrease in the currently searched index. Through this, the weight variance may be determined by performing reductions on each decrease of indices in which the first value is found from the maximum value of the target time interval.

In operation 3390, the learning device of the neuron module may search for a next bit by increasing an index for searching for a bit by one (1).

The descriptions provided with reference to FIGS. 1 to 31 may be applicable to each operation shown in FIGS. 32 and 33, and thus, detailed descriptions thereof have been omitted for the sake of brevity.

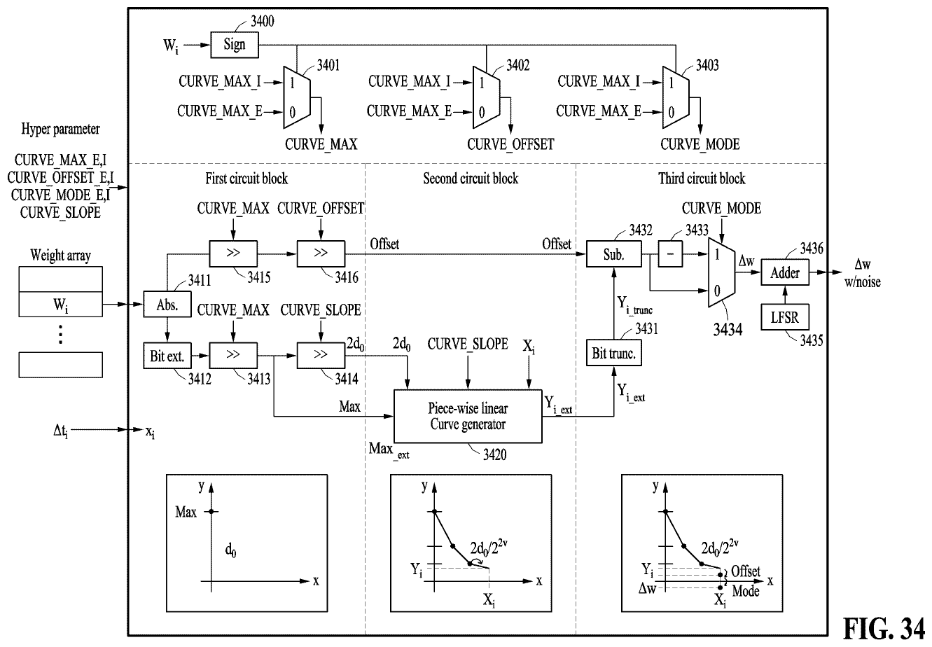

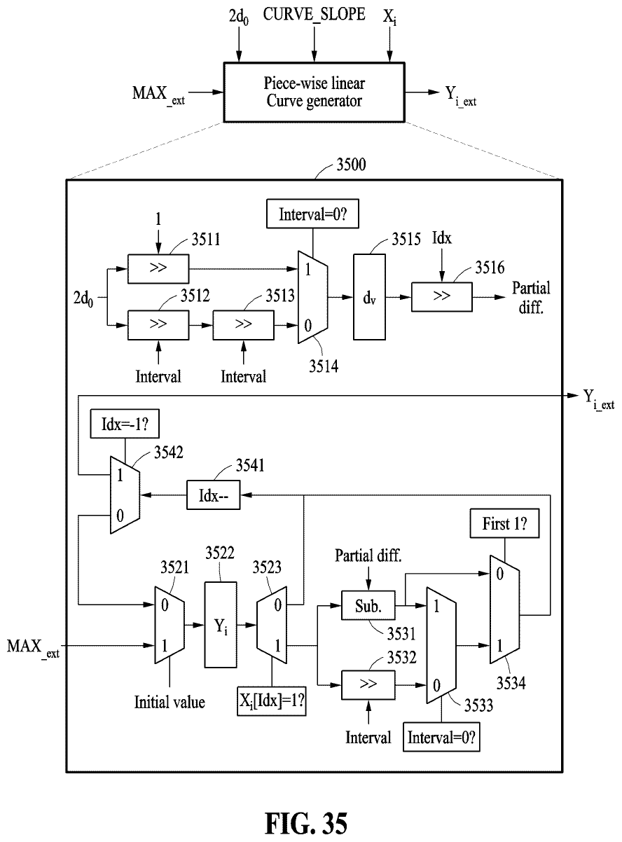

FIGS. 34 and 35 are block diagrams illustrating an operation of a learning device of a neuron module to determine a weight variance, according to an embodiment.

Referring to FIG. 34, a block diagram of a weight variance generator in the learning device of the neuron module is exemplarily illustrated. The weight variance generator may include a first circuit block and a second circuit block. The weight variance generator may further include a third circuit block.

The weight variance generator may receive hyperparameters including CURVE_MAX_E, I, CURVE_OFFSET_E, I, CURVE_MODE_E, I, and CURVE_SLOPE, and an existing weight Wₚᵣₑᵥ of a synapse, and a time difference AT. The weight variance generator may receive a weight array for a plurality of synapses in the form of an array to receive the existing weight of the plurality of synapses connected to the neuron module. In addition, Δt; may represent a time difference of an i-th synapse. Δtᵢ may be shown as a time difference xᵢ input to the graph.

A block 3400 may receive the existing weight of the synapse to determine a learning rule from the eSTDP learning rule or the iSTDP learning rule to train the neuron module, may determine a sign of the existing weight based on the MSB, and may transmit the sign to a first multiplexer (MUX) 3401, a second MUX 3402, and a third MUX 3403. When the sign of the existing weight of the synapse is “+”, the block 3400 may output “0”, and when the sign of the existing weight of the synapse is “−”, the block 3400 may output “1”.

When “1” is input to the first MUX 3401, the second MUX 3402, and the third MUX 3403 as a selected signal, the first MUX 3401, the second MUX 3402, and the third MUX 3403 may output CURVE_MAX_I, CURVE_OFFSET_I, and CURVE_MODE_I received by input terminals “1” for iSTDP learning, and when “0” is input to the first MUX 3401, the second MUX 3402, and the third MUX 3403, the first MUX 3401, the second MUX 3402, and the third MUX 3403 may output CURVE_MAX_E, CURVE_OFFSET_E, and CURVE_MODE_E received by input terminals “0” for eSTDP learning, respectively.

A value output from the first MUX 3401 may be used as a first hyperparameter to determine a maximum value of the graph. A value output from the second MUX 3402 may be used as a third hyperparameter related to an offset to be applied to the graph. A value output from the third MUX 3403 may be used as a fourth hyperparameter related to the shape of the graph.

The first circuit block may determine an initial value to generate the graph.

A block 3411 may determine an absolute value of the received existing weight of an synapse and may transmit the absolute value to a block 3412 and a first shifter 3415 to determine a graph shape according to a mode after implementing the graph on the first quadrant regardless of the sign of the existing weight.

The block 3412 may perform bit extension on an LSB side and may transmit the extended LSB to a shifter 3413 to prevent a decrease in the accuracy as bits of the LSB side of the absolute value of the existing weight may be lost. For example, the block 3412 may perform bit extension by adding 4′b0000 bits to the LSB side of bits representing the absolute value of the existing weight.

The shifter 3413 may determine a maximum value Max of the graph by shifting the bits representing the absolute value of the received existing weight according to CURVE_MAX, and may transmit Max to a shifter 3414 and a curve generator 3420. In FIG. 34, Maxₑₓₜ may represent a bit-extended Max value.

The shifter 3413 may shift bits representing the maximum value of the received graph according to CURVE_SLOPE, may determine a reference decrease d₀, and may transmit 2d₀ to the curve generator 3420. In this case, 2d₀ may be a bit-extended value by the block 3412.

The first shifter 3415 may shift the bits representing the absolute value of the received weight based on CURVE_MAX, and may transmit the shifted bits to a second shifter 3416.

The second shifter 3416 may determine an offset by shifting bits received from the first shifter 3415 based on CURVE_OFFSET, and may transmit the determined offset to a subtractor 3432.

Although FIG. 34 illustrates that the first and second shifters 3415 and 3416 are included in the first circuit block for description, the embodiment is not limited thereto, and the first and second shifters 3415 and 3416 may be included in the second circuit block or the third circuit block.

The second circuit block may include the curve generator 3420 to determine a weight variance by generating a graph. The curve generator 3420 may determine a weight variance Y_{i_ext} corresponding to the time difference xᵢ using 2d₀, Maxₑₓₜ, and CURVE_SLOPE, and may transmit Y_{i_ext} to a block 3431. Operation of the curve generator 3420 is described with reference to FIG. 35.

The third circuit block may apply an offset, a mode, and noise to the weight variance Y_{i_ext} determined by a determined curve generator.

The block 3431 may determine Y_{i_trunc} by performing truncation of a bit to convert the received Y_{i_ext} into the original number of bits before the bit extension, and may transmit Y_{i_trunc} to the subtractor 3432.

The subtractor 3432 may apply an offset to the received Y_{i_trunc} and may transmit Y_{i_trunc} to a block 3433 and a fourth MUX 3434. When the offset is “0”, the subtractor 3432 may not apply the offset.

The block 3433 may change a sign of a value received from the subtractor 3432 and may transmit the value to the fourth MUX 3434.

The fourth MUX 3434 may select a value received by an input terminal “1” as the sign is changed according to CURVE_MODE, or may select a value received by an input terminal “0” without a change in the sign, and may transmit the selected value to an adder 3436.

An LFSR 3435 may generate a random number using a shift register and may transmit the random number to the adder 3436. However, the LFSR 3435 may represent another block that is able to generate a random number depending on the embodiment.

The adder 3436 may add the random number received from the LFSR 3435 to a weight variance received from the fourth MUX 3434. Through this, the adder 3436 may output a weight variance added with noise. The weight variance generator may implement STDP that is stochastic rather than deterministic by adding the noise.

Referring to FIG. 35, a block diagram of a curve generator 3500 in a weight variance generator is exemplarily illustrated.

A shifter 3511 may shift bits representing 2d₀ to the right side by one (1) and may transmit the shifted bits to a first MUX 3514. That is, a value output from the shifter 3511 may be d₀.

When a target time interval is time interval v, the bits representing 2d₀ may be shifted to the right side by 2v through a first shifter 3512 and a second shifter 3513, and may be transmitted to the first MUX 3514. That is, a value output from the second shifter 3513 may be d₀/2^{2v-1}.

When the target time interval corresponds to time interval 0, the first MUX 3514 may transmit a value received by an input terminal “1” to a block 3515, and when the target time interval does not correspond to time interval 0, the first MUX 3514 may transmit a value received by an input terminal “0” to the block 3515.

The value transmitted to the block 3515 may be determined to be a target decrease dᵥ with respect to the target time interval and may be transmitted to a third shifter 3516.

The third shifter 3516 may shift bits representing the target decrease by a currently searched index to determine a decrease in the index. In FIG. 35, for ease of description, the decrease in the index may be referred to as “partial diff.”

A loop including a second MUX 3521, a block 3522, a first demultiplexer (DMUX) 3523, a block 3541, and a second DMUX 3542 may be configured to search for a first value in bits of a time difference.

When a currently searched index is an MSB, the second MUX 3521 may transmit Maxₑₓₜ received by an input terminal “1” to the block 3522, and when the currently searched index is not the MSB, the second MUX 3521 may transmit a value received by the input terminal “0” to the block 3522.

The block 3522 may store the received value as a value Yᵢ to determine a weight variance.

When a bit of the currently searched index is not the first value, the first DMUX 3523 may transmit Yᵢ to an output terminal “0”, and when the bit is the first value, the first DMUX 3523 may transmit Yᵢ to an output terminal “1”.

A loop including a subtractor 3531, a fourth shifter 3532, a third MUX 3533, a fourth MUX 3534, a block 3541, and a second DMUX 3542 may be configured to search for a target time interval and determine a weight variance using a decrease in an index.

The subtractor 3531 may subtract the decrease in the currently searched index from the received Yᵢ and may transmit a result thereof to the third and fourth MUXs 3533 and 3534.

The fourth shifter 3532 may shift bits representing the received Yᵢ by v and may transmit the shifted bits to the third MUX 3533.

The third MUX 3533 may determine whether the target time interval is time interval 0 (e.g., whether v is 0), and if the target time interval is time interval 0, the third MUX 3533 may transmit a value received by the input terminal “1” to the fourth MUX 3534, and if the target time interval is not time interval 0, the third MUX 3533 may transmit a value received by the input terminal “0” to the fourth MUX 3534. That is, the third MUX 3533 may determine a maximum value of the target time interval.

When the first value found in the current index is an initially found first value, the fourth MUX 3534 may transmit a value received by the input terminal “1” to the block 3541, and when the first value is not an initially found first value, the fourth MUX 3534 may transmit a value received by the input terminal “0” to the block 3541. That is, the fourth MUX 3534 may determine the target time interval or may reduce Yᵢ by the decrease in the index.

When Yᵢ is received, the block 3541 may reduce the currently searched index idx by one (1) and may move to a next index to search.

The second DMUX 3542 may determine whether the currently searched index idx is “−1”. That is, the second DMUX 3542 may determine whether the bits representing the time difference are searched up to the LSB. When the currently searched index idx is not “−1”, the second DMUX 3542 may transmit the received Yᵢ to the second MUX 3521, and when the currently searched index idx is “−1”, the second DMUX 3542 may output the received Yᵢ to Y_{i_ext}.

The descriptions provided with reference to FIGS. 1 to 33 may be applicable to each operation shown in FIGS. 34 and 35, and thus, detailed descriptions thereof have been omitted for the sake of brevity.

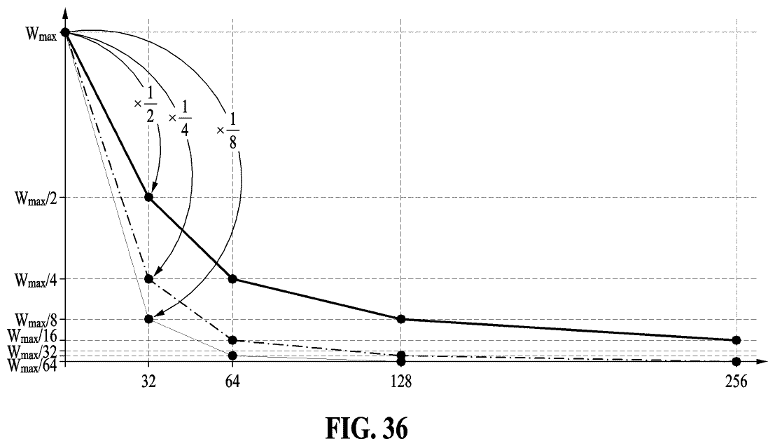

FIG. 36 is a diagram illustrating an operation of determining a graph by fixing the number of time intervals, according to an embodiment.

Referring to FIG. 36, a graph 3600 that adjusts a slope by fixing the number of time intervals and differently setting a ratio of changing a maximum value for each time interval unlike the embodiments of FIGS. 10 and 11 are exemplarily illustrated. That is, in the graph 3600, in both ΔT and ΔW, time intervals are distinguished by log₂ scales, but a second hyperparameter represents a ratio of decreasing a maximum value of each time interval, and thereby, the slope of the graph 3600 may be determined.

For example, as shown in FIG. 36, in the graph 3600, as the number of time intervals is fixed to four (4), and ratios of decreasing maximum values of respective time intervals are determined to be ½ (shown as a thick solid line), ¼ (shown as a dashed line), and ⅛ (shown as a thin solid line), the slope may be determined.

When the learning device of the neuron module is used for simulating the natural neural network or is used in a machine learning processor, it may be advantageous to implement as many various graphs as possible for the optimal STDP learning, and the hardware cost may also be considered. Therefore, depending on the embodiment, the graph may be determined using a method that is more appropriate to a specific application in the embodiments of FIG. 10, 11, or 36.

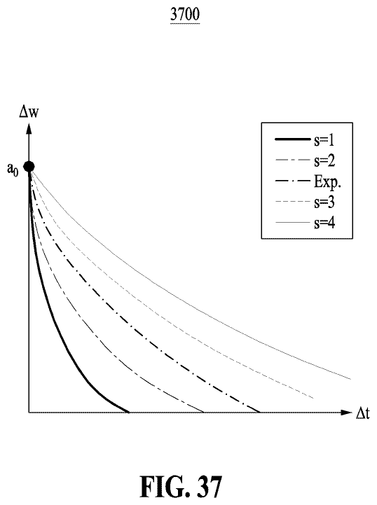

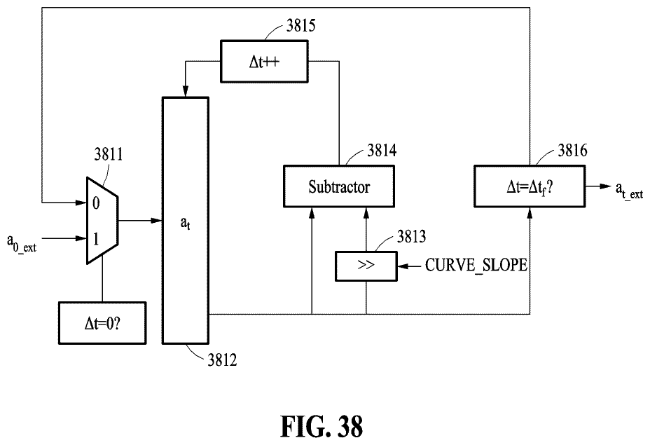

FIGS. 37 and 38 are diagrams illustrating an operation of determining a graph using a subtractor, according to an embodiment.

Referring to FIG. 37, a graph 3700 determined using a shifting and subtracting scheme using a shifter and a subtractor rather than a piece-wise linear scheme is exemplarily illustrated. If the number of cycles does not need to be considered or a time window of ΔT has a significantly short time step, the graph 3700 may be determined using the shifting and subtracting scheme.

In FIG. 37, a₀ may represent a maximum value of the graph, and s may represent CURVE_SLOPE. Each graph may be determined by Equation 5 shown below.

$${a}_{t} = {a}_{t - 1} - \frac{{a}_{t - 1}}{{2}^{s}} \qquad [ Equation 5 ]$$

Referring to Equation 5, aₜ may represent a weight variance when ΔT is t.

The shifting and subtracting scheme may use the weight variance generator of FIG. 34, but may use a shifting and subtracting block of FIG. 38 instead of the piece-wise linear curve generator.

The shifting and subtracting scheme may implement an exponential curve with low hardware cost.

Referring to FIG. 38, a block diagram of a shifting and subtracting block is exemplarily illustrated.

In FIG. 38, ΔT may represent a cycle that operates a circuit rather than representing a time difference between spikes input to a weight variance generator. For example, when 200 is input to the weight variance generator as a time difference between spikes, Δt_{f} (in FIG. 38, shown as Δt_{f}) of a block 3816 may be 200 and ΔT may increase up to 200 starting from zero (0) through a block 3815. Through this, a shifter 3813 and a subtractor 3814 may operate through 200 cycles. That is, in FIG. 38, when ΔT is input to the weight variance generator, ΔT may represent a value that increases from zero (0) to the time difference between spikes.

An MUX 3811 may determine whether ΔT is “0”, and when ΔT is “0”, the MUX 3811 may transmit a maximum value a_{0_ext} of a bit-extended graph received by the input terminal “1” to a block 3812, and when ΔT is not “0”, the MUX 3811 may transmit a value received by the input terminal “0” to the block 3812. That is, only when a_{0_ext}, the MUX 3811 may transmit a_{0_ext} to the block 3812 and thereafter, during the cycles as many as the value input as the time difference between spikes, a result of the block 3816 may be transmitted to the block 3812.

The block 3812 may store a value received from the MUX 3811 as a weight variance aₜ at a cycle determined by the block 3815. The block 3812 may transmit aₜ to the shifter 3813, the subtractor 3814, and the block 3816.

The shifter 3813 may shift bits representing the received at to the right side by CURVE_SLOPE.

The subtractor 3814 may transmit, to the block 3815, a value obtained by subtracting a value received from the shifter 3813 from a value received from the block 3812.

When the block 3815 receives the value from the subtractor 3814, the block 3815 may increase a value of ΔT by one (1) and may transmit the received value to the block 3812.

The block 3816 may determine whether the current ΔT is Δt_{f}. In FIG. 38, Δt_{f} may represent a time difference between a post-spike and a pre-spike. When the current ΔT is Δt_{f}, the block 3816 may output the received at value.

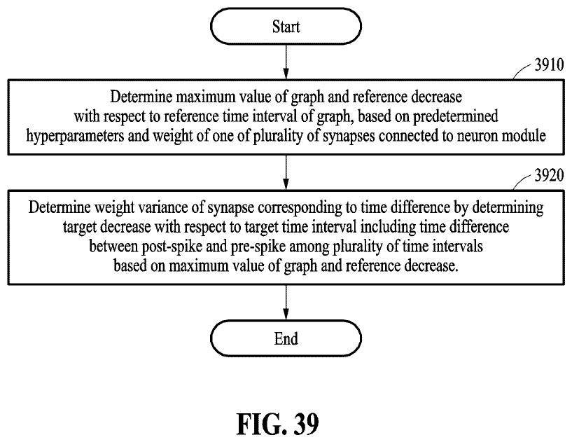

FIG. 39 is a flowchart illustrating an operation method of a learning device of a neuron module, according to an embodiment.

In operation 3910, the learning device of the neuron module may determine a maximum value of a graph for updating a weight and a reference decrease in the graph with respect to a reference time interval of a plurality of time intervals of the graph, based on predetermined hyperparameters and one of weights of a plurality of synapses connected to the neuron module in a spiking neural network.

In operation 3920, the learning device of the neuron module may determine a weight variance of a synapse corresponding to a time difference by determining a target decrease in the graph with respect to a target time interval including a time difference between a post-spike occurring in the neuron module and a pre-spike occurring in a synapse among the plurality of time intervals, based on the maximum value of the graph and the reference decrease. The learning device of the neuron module may sequentially search for a first value from an MSB of bits representing the time difference and may determine the target time interval from the plurality of time intervals using an index in which the first value is initially found. The learning device of the neuron module may determine a maximum value of the target time interval by shifting bits representing the maximum value of the graph based on the index in which the first value is initially found and may determine the weight variance of the synapse based on the maximum value of the target time interval and the target decrease. The learning device of the neuron module may determine the target decrease by shifting bits representing the reference decrease based on the index in which the first value is initially found. The learning device of the neuron module may determine the weight variance of the synapse using the target decrease and indices in which the first value is found after the index in which the first value is initially found among the bits representing the time difference. The learning device of the neuron module may determine a decrease in each index by shifting bits representing a target decrease by each index with respect to the indices in which the first value is found, and may determine a weight variance of a synapse by subtracting the decrease in each index from a maximum value of the target time interval.

The weight of the synapse may be updated based on the weight variance, and the graph may include linear graphs respectively included in the plurality of time intervals.

The learning device of the neuron module may determine a sign of the weight variance according to a sign of the time difference based on a parameter related to a shape of the graph among the hyperparameters. The learning device of the neuron module may adjust the weight variance by an offset based on a parameter related to the offset applied to the graph among the hyperparameters. The learning device of the neuron module may add noise to a weight variance by applying a random number to the weight variance.

The learning device of the neuron module may improve the spatial efficiency and may update weights of connected synapses using a runtime reconfigurable weight variance generator.

The descriptions provided with reference to FIGS. 1 to 38 may be applicable to each operation shown in FIG. 39, and thus, detailed descriptions thereof have been omitted for the sake of brevity.

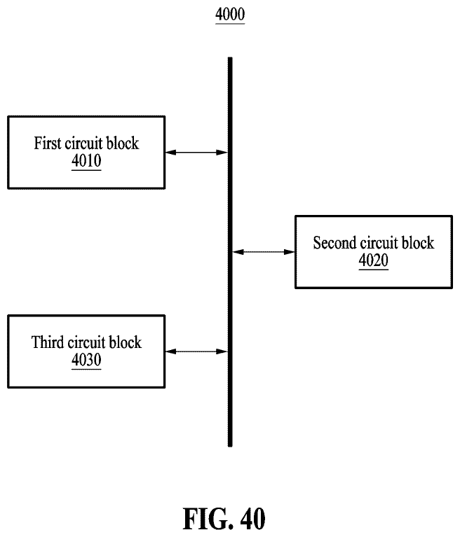

FIG. 40 is a block diagram illustrating a learning device of a neuron module, according to an embodiment.

Referring to FIG. 40, a learning device 4000 of a neuron module may include a first circuit block 4010 and a second circuit block 4020. The learning device 4000 of the neuron module may further include a third circuit block 4030.

The first circuit block 4010 may determine a maximum value of a graph for updating a weight and a reference decrease in the graph with respect to a reference time interval of a plurality of time intervals of the graph, based on predetermined hyperparameters and one of weights of a plurality of synapses connected to the neuron module in a spiking neural network.

The second circuit block 4020 may determine a weight variance of a synapse corresponding to a time difference by determining a target decrease in the graph with respect to a target time interval including a time difference between a post-spike occurring in the neuron module and a pre-spike occurring in a synapse among the plurality of time intervals, based on the maximum value of the graph and the reference decrease.

The second circuit block 4020 may sequentially search for a first value from an MSB of bits representing the time difference and may determine the target time interval from the plurality of time intervals using an index in which the first value is initially found. The second circuit block 4020 may determine a maximum value of the target time interval by shifting bits representing the maximum value of the graph based on the index in which the first value is initially found, and may determine the weight variance of the synapse based on the maximum value of the target time interval and the target decrease. The second circuit block 4020 may determine the target decrease by shifting bits representing the reference decrease based on the index in which the first value is initially found. The second circuit block 4020 may determine a weight variance of a synapse using a target decrease and indices in which the first value is found after the index in which the first value is initially found among the bits representing the time difference. The second circuit block 4020 may determine a decrease in each index by shifting bits representing a target decrease by each index with respect to the indices in which the first value is found, and may determine a weight variance of a synapse by subtracting the decrease in each index from a maximum value of the target time interval.

The number of time intervals may be determined based on a parameter related to the reference time interval among the hyperparameters and the number of bits of the time difference.

The third circuit block 4030 may determine a sign of the weight variance according to a sign of the time difference based on a parameter related to a shape of the graph among the hyperparameters. The third circuit block 4030 may adjust the weight variance by an offset based on a parameter related to the offset applied to the graph among the hyperparameters. The third circuit block 4030 may add noise to a weight variance by applying a random number to the weight variance.

The hyperparameters may be determined based on a learning rule of the plurality of synapses.

In addition, the learning device 4000 of the neuron module may process the operations described above with reference to FIGS. 1 to 39.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art may appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct and/or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc-read only memory (CD-ROM) discs, digital versatile discs (DVDs), and/or Blue-ray discs; magneto-optical media such as optical discs; and hardware devices that are specially configured to store and perform program instructions, such as read-only memory (ROM), random access memory (RAM), flash memory (e.g., universal serial bus (USB) flash drives, memory cards, memory sticks, or the like), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A learning device of a neuron module, the learning device comprising:
a memory storing instructions; and
one or more processors communicatively coupled to the memory, wherein the one or more processors are configured to execute the instructions to:
determine, based on predetermined hyperparameters and a weight of a synapse of a plurality of synapses coupled with the neuron module in a spiking neural network, a maximum value of a graph and a reference decrease of the graph with respect to a reference time interval from among a plurality of time intervals of the graph;
determine, based on the maximum value and the reference decrease, a weight variance of the synapse corresponding to a time difference between a post-spike occurring in the neuron module and a pre-spike occurring in the synapse by determining a target decrease of the graph with respect to a target time interval comprising the time difference from among the plurality of time intervals; and
update the weight of the synapse based on the weight variance,
wherein the graph comprises linear graphs respectively comprised in the plurality of time intervals.

2. The learning device of claim 1, wherein the one or more processors are further configured to execute the instructions to:
sequentially search for a first value from a most significant bit (MSB) among bits representing the time difference; and
determine the target time interval from the plurality of time intervals using a first index in which the first value is initially found.

3. The learning device of claim 2, wherein the one or more processors are further configured to execute the instructions to:
determine a maximum value of the target time interval by shifting bits representing the maximum value of the graph based on the first index; and
determine the weight variance of the synapse based on the maximum value of the target time interval and the target decrease.

4. The learning device of claim 2, wherein the one or more processors are further configured to execute the instructions to:
determine the target decrease by shifting bits representing the reference decrease based on the first index.

5. The learning device of claim 2, wherein the one or more processors are further configured to execute the instructions to:
determine the weight variance of the synapse using the target decrease and indices in which the first value is found after the first index from among the bits representing the time difference.

6. The learning device of claim 5, wherein the one or more processors are further configured to execute the instructions to:
determine a decrease in each index by shifting bits representing the target decrease by each index for the indices in which the first value is found; and
determine the weight variance of the synapse by subtracting the decrease in each index from the maximum value of the target time interval.

7. The learning device of claim 1, wherein the one or more processors are further configured to execute the instructions to:
determine a number of the plurality of time intervals based on a parameter related to the reference time interval among the hyperparameters and a number of bits of the time difference.

8. The learning device of claim 1, wherein the one or more processors are further configured to execute the instructions to:
determine a sign of the weight variance based on a sign of the time difference based on a parameter related to a shape of the graph among the hyperparameters.

9. The learning device of claim 8, wherein the one or more processors are further configured to execute the instructions to:
adjust the weight variance by an offset based on a parameter related to an offset applied to the graph among the hyperparameters.

10. The learning device of claim 8, wherein the one or more processors are further configured to execute the instructions to:
add noise to the weight variance by applying a random number to the weight variance.

11. The learning device of claim 1, wherein the one or more processors are further configured to execute the instructions to:
determine the hyperparameters based on a learning rule of the plurality of synapses.

12. A method of operating a learning device of a neuron module, the method comprising:
determining, based on predetermined hyperparameters and a weight of a synapse of a plurality of synapses coupled with the neuron module in a spiking neural network, a maximum value of a graph and a reference decrease of the graph with respect to a reference time interval from among a plurality of time intervals of the graph;
determining, based on the maximum value and the reference decrease, a weight variance of the synapse corresponding to a time difference between a post-spike occurring in the neuron module and a pre-spike occurring in the synapse by determining a target decrease of the graph with respect to a target time interval comprising the time difference from among the plurality of time intervals; and
updating the weight of the synapse based on the weight variance,
wherein the graph comprises linear graphs respectively comprised in the plurality of time intervals.

13. The method of claim 12, wherein the determining of the weight variance comprises:
sequentially searching for a first value from a most significant bit (MSB) among bits representing the time difference; and
determining the target time interval from the plurality of time intervals using a first index in which the first value is initially found.

14. The method of claim 13, wherein the determining of the weight variance further comprises:
determining a maximum value of the target time interval by shifting bits representing the maximum value of the graph based on the first index; and
determining the weight variance of the synapse based on the maximum value of the target time interval and the target decrease.

15. The method of claim 13, wherein the determining of the weight variance further comprises:
determining the target decrease by shifting bits representing the reference decrease based on the first index.

16. The method of claim 13, wherein the determining of the weight variance further comprises:
determining the weight variance of the synapse using the target decrease and indices in which the first value is found after the first index from among the bits representing the time difference.

17. The method of claim 16, wherein the determining of the weight variance further comprises:
determining a decrease in each index by shifting bits representing the target decrease by each index for the indices in which the first value is found; and
determining the weight variance of the synapse by subtracting the decrease in each index from the maximum value of the target time interval.

18. The method of claim 12, further comprising:
determining a sign of the weight variance based on a sign of the time difference based on a parameter related to a shape of the graph among the hyperparameters.

19. The method of claim 18, wherein the determining of the sign of the weight variance comprises:
adjusting the weight variance by an offset based on a parameter related to an offset applied to the graph among the hyperparameters.

20. The method of claim 18, wherein the determining of the sign of the weight variance comprises:
adding noise to the weight variance by applying a random number to the weight variance.
